(19) United States
(12) Patent Application Publication
(10) Pub. No.: US 2026/0028502 A1
(43) Pub. Date: Jan. 29, 2026

(54) RESIN COMPOSITIONS, POLYMERS MADE FROM THE RESIN COMPOSITION, METHODS OF MAKING THE POLYMER, AND METHODS AND SYSTEMS OF MAKING STRUCTURES THAT INCLUDE THE POLYMER

(71) Applicant: University of Virginia Patent Foundation, Charlottesville, VA (US)

(72) Inventors: Daniel Andrew Rau, Laramie, WY (US); Liheng Cai, Charlottesville, VA (US); Myoeum Kim, Charlottesville, VA (US)

(21) Appl. No.: 19/217,343

(22) Filed: May 23, 2025

Related U.S. Application Data
(60) Provisional application No. 63/674,728, filed on Jul. 23, 2024.

(51) Int. Cl. C09D 133/14; B29C 64/124; B29K 33/00; B29K 105/00; B33Y 70/00; C08F 220/18; C09D 4/00

(52) U.S. Cl. CPC C09D 133/14; B33Y 70/00; C08F 220/1804; C09D 4/00; B29C 64/124; B29K 2033/08; B29K 2105/0085; C08F 2800/20; C08F 2810/20; C08F 2810/50

(57) ABSTRACT

The present disclosure provides for resin compositions, polymers made from the resin composition, methods of making the polymer, methods and systems of making structures that include the polymer, and the like.

### CROSS-REFERENCE TO RELATED APPLICATIONS

This application claims the benefit of U.S. Provisional Application entitled “MODULAR SOFT STRETCHABLE ELASTOMERS FOR STEREOLITHOGRAPHY PRINTING STRUCTURES WITH EXTREME DISSIPATIVE PROPERTIES” and having Ser. No. 63/674,728, filed Jul. 23, 2024, which is herein incorporated by reference in its entirety.

### FEDERAL SPONSORSHIP

This invention was made with government support under 1944625 awarded by the National Science Foundation. The government has certain rights in the invention.

### BACKGROUND

Additive manufacturing (AM) of elastomers enables the fabrication of many technologically important structures and devices. Among various kinds of methods, vat photopolymerization (VP) printing represents one of the most used additive manufacturing techniques, largely because of its capability in fabricating complex three-dimensional (3D) structures with relatively high resolution and smooth finishes. However, the feedstock polymeric resins are limited by the nature of VP printing. In VP printing, a thin layer of liquid photopolymer is selectively solidified by light-activated polymerization. After the layer is cured, the build platform moves vertically, exposing the cured layer to a new layer of liquid resin. This process requires the resin to be of relatively low viscosity, such that the resin can easily flow to replenish the space between the cured part and the light source. Currently, the majority of VP resins are acrylate-based photocurable polymers, which often form highly crosslinked stiff, brittle networks. However, currently used polymers include multiple problems. It remains an unmet demand in the development of low-cost, soft, and stretchable elastomeric resins for VP printing.

### SUMMARY

The present disclosure provides for resin compositions, polymers made from the resin composition, methods of making the polymer, methods and systems of making structures that include the polymer, and the like.

The present disclosure provides for compositions comprising: an alkyl acrylate monomer, wherein the weight percent of the alkyl acrylate monomer in the composition is about 90 to 99 weight percent; an alkyldiol diacrylate monomer, wherein the weight percent of alkyldiol diacrylate monomer in the composition is about 0.01 to 10 weight percent; and 2-[(alkylamine)carbonyl]oxy]alkyl acrylate monomer, wherein the weight percent of 2-[(alkylamine)carbonyl]oxy]alkyl acrylate monomer in the composition is about 0.01 to 2 weight percent.

The present disclosure provides for compositions comprising: a butyl acrylate monomer, wherein the weight percent of the butyl acrylate monomer in the composition is about 90 to 99 weight percent; a butanediol diacrylate monomer, wherein the weight percent of butanediol diacrylate monomer in the composition is about 0.01 to 10 weight percent; and 2-[(ethylamine)carbonyl]oxy]ethyl acrylate monomer, wherein the weight percent of 2-[(ethylamine)carbonyl]oxy]ethyl acrylate monomer in the composition is about 0.01 to 2 weight percent.

The present disclosure provides for compositions comprising a polymer having the following group:

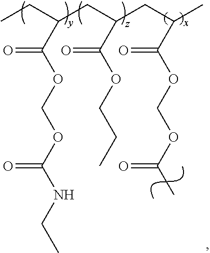

wherein x is 1 to 100,000, wherein y is 1 to 100,000, wherein z is 1 to 100,000.

The present disclosure provides for methods of making a structure using stereolithography printing, comprising: disposing a first layer of a composition, wherein the composition comprises: a butyl acrylate monomer, wherein the weight percent of the butyl acrylate monomer in the composition is about 90 to 99 weight percent; a butanediol diacrylate monomer, wherein the weight percent of butanediol diacrylate monomer in the composition is about 0.01 to 10 weight percent; 2-[(ethylamine)carbonyl]oxy]ethyl acrylate monomer, wherein the weight percent of 2-[(ethylamine)carbonyl]oxy]ethyl acrylate monomer in the composition is about 0.01 to 2 weight percent; and a photoinitiator; exposing the first layer to ultraviolet energy to polymerize the composition to form an elastomer; disposing a second layer of the composition onto at least the first layer or onto the first layer; exposing the second layer to ultraviolet energy to polymerize the composition to form the elastomer, wherein the structure comprises the first layer and the second layer.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1E illustrate the design and synthesis of modular soft stretchable photocurable elastomer resins for vat photopolymerization printing. FIG. 1A illustrates the resin consists of spacer, sticker, and crosslinker monomers, which can form a network under ultraviolet (UV) triggered free radical polymerization with the help from a photoinitiator phenyl bis(2,4,6-trimethylbenzoyl)phosphine oxide (BAPO). FIG. 1B illustrates a schematic of the cured polymer network. Short green links: crosslinkers in (FIG. 1A); black lines: poly(butyl acrylate); empty circles: amide groups; a pair of closed circles: an amide-amide double hydrogen bond. FIG. 1C illustrates a schematic of the VP printing process. Patterned UV selectively cures the resin layer-by-layer to create complex three-dimensional (3D) objects. FIG. 1D a 3D printed gyroid structure from the elastomer resin before and during compression by hand. The part has been dyed opaque for visualization. FIG. 1E an optical image showing that the cured resin is transparent.

FIGS. 2A-2F illustrate vat photopolymerization printing of soft elastomers. FIG. 2A illustrates the dependence of gelation time after initial exposure to UV irradiation, t_{g}, on the crosslinker concentration of our elastomer resins. Inset: Crosslinking kinetics for the resin formulation with 0.75% crosslinker. The gelation time is defined as the time beyond which G′ becomes greater than G″, which are quantified using small amplitude oscillatory shear measurements at a frequency of 1 Hz and a strain of 0.5% at 20° C. The gap between two parallel plates is 100 μm, comparable to the thickness of each layer during printing. FIG. 2B-C illustrates printed (FIG. 2B) 3D lattice and (FIG. 2C) gyroid from the resin formulation with 0.5% crosslinker. The parts are dyed opaque for visualization. Scale bars, 5 mm. FIG. 2D illustrates photos of the printed elastomer with 0.3% crosslinker stretched to strains of 0 (upper) and 13.5 (lower). FIG. 2E illustrates stress-strain behavior of 3D printed tensile bars using resins with various crosslinker concentrations at room temperature under a strain rate of 0.022 s⁻¹. FIG. 2F illustrates an Ashby plot of the Young's modulus and tensile breaking strain of elastomer resins for VP printing. Red circles: 3D printed (empty) and molded (filled) tensile bars of our elastomer resins; light color regions: existing photocurable resins for VP printing (Table S8).

FIGS. 3A-3D illustrates compression properties of printed elastomers and 3D structures. FIG. 3A illustrates compressive stress-strain curves of printed cylinders with various crosslinker concentrations. Inset: Zoom-in of the compressive stress-strain curves at small strains. FIG. 3B illustrates representative photos of printed cylinders using resins with 2.5% (upper) and 0.3% (lower) crosslinkers. The elastomer with 2.5% crosslinker fractures at 50% compressive strain, while the elastomer with 0.3% crosslinker can be compressed to 80% strain without fracture. FIG. 3C illustrates compressive stress-strain curves of 3D printed tetrakaidecahedron lattice structures at various relative densities. All structures are printed from the S0.5 resin. FIG. 3D illustrates apparent modulus increases and energy dissipation efficiency remains roughly constant with increasing relative density of the 3D printed tetrakaidecahedron lattice structures.

FIGS. 4A-4F illustrate 3D printing of energy dissipative structures for protecting soft brain-like gel from impact. FIG. 4A illustrates an experimental setup that uses a falling stainless-steel ball to produce impacts on the brain-like gel. A high-speed camera measures the deformation of the brain-like gel during impact and a piezoelectric sensor quantifies the relative magnitude of the impact force. Higher voltages correspond to higher forces. FIG. 4B illustrates photos of the brain-like gel being deformed during impact. Left: without any protection; right: with the protection of a 3D printed tetrakaidecahedron lattice structure. FIG. 4C illustrates photos of the 3D printed protection structure before (left) and during (right) deformation. Dashed circle outlines the falling stainless ball. FIG. 4D illustrates strain, acceleration, and voltage (force) measured during the impact on the soft brain-like gel. Gray curves: no protection; blue curves: protected by the bulk soft, stretchable elastomer (0.5% crosslinker resin); orange curves: 3D printed tetrakaidecahedron structure with 29.0% relative density. FIG. 4E illustrates illustration of the modified head impact criteria (mHIC) that quantifies both the magnitude and duration of the acceleration to measure the relative severity of the impact in the context of traumatic brain injury. FIG. 4F illustrates the mHIC parameter, minimum acceleration, and maximum voltage of the soft brain-like gel under the protection of the bulk soft, stretchable elastomer (0.5% crosslinker resin, squares), as well as of the printed 3D structures of different relative densities (diamonds).

FIG. 5 illustrates a H NMR spectrum (600 MHZ, CDCl₃) of the synthesized 2-[[ethyl(amine)carbonyl]oxy]ethyl acrylate (EAEA) sticky monomer.

FIGS. 6A-6F illustrates crosslinking kinetics for resins with different crosslinker concentrations. Higher crosslinker concentration results in shorter gel time and higher modulus. (FIG. 6A) 0.2% crosslinker (FIG. 6B) 0.3% crosslinker (FIG. 6C) 0.5% crosslinker (FIG. 6D) 0.75% crosslinker (FIG. 6E) 1.0% crosslinker (FIG. 6F) 2.5% crosslinker. A 100 μm gap and 17 mW/cm² irradiance was used for all measurements.

FIG. 7 illustrates photorheology of the resin with 0.5% crosslinker and 49% stickers. Compared to the resin containing only 0.5% crosslinker (100% spacer monomer), the resin with stickers exhibits a shorter gelation time and a higher modulus. These results suggest that similar trends may be observed across a broader range of sticker concentrations, potentially including up to 100%.

FIG. 8 illustrates linear relationship between Young's modulus (tensile) and crosslinker concentration for 3D-printed samples. Filled red symbol represents the sample containing 49% sticker monomer. All measurements are performed at a strain rate of 0.052 s⁻¹.

FIG. 9 illustrates frequency sweep of elastomers with different crosslinker concentrations. Dependencies of storage (solid symbols, G′) and loss (open symbols, G″) moduli on the oscillatory shear frequency. All measurements are performed a fixed strain of 0.5% at 20° C.

FIG. 10 illustrates the shear storage modulus of the resins increases linearly with crosslinker concentration. Filled red symbol represents the sample containing 49% sticker monomer. All measurements are performed at 0.5% strain and oscillatory frequency of 0.1 rad/s.

FIG. 11 illustrates temperature sweep of elastomers with different crosslinker concentrations. Temperature dependence of G′ (solid line) and G″ (dashed line) from −40° C. to 200° C. All measurements are performed with a fixed strain of 0.5% and 1 Hz.

FIG. 12 illustrates tensile properties of molded elastomers. Stress-strain behavior of cast tensile bars using resins with various crosslinker concentrations at room temperature under a strain rate of 0.022 s−1.

FIG. 13 illustrates tensile properties of two separate batches of the 0.5% crosslinker samples. The two batches were synthesized, printed, and tested separately.

FIG. 14 illustrates the repeated cyclical compression to 50% strain of a gyroid printed from the resin containing 0.5% crosslinker. The printed part can be repeatably deformed without suffering a significant decrease in mechanical properties.

FIG. 15 illustrates cyclic compression test of 3D printed tetrakaidecahedron structures. The 19.5% relative density structure has a compressive modulus of 5.2 kPa, the 29.0% relative density structure has a modulus of 19.2 kPa and the 35.3% relative density structure has a modulus of 42.4 kPa recorded at 0.05 strain. All structures are printed from the resin containing 0.5% crosslinker (S0.5) and are used to protect soft materials from impacts. Solid line: loading; dashed line: unloading.

FIG. 16 illustrates comparison of the bulk elastomer to 3D structures with various relative density. The 3D printed impact absorption structures are softer than the bulk material and can be strained to 80% deformation with minimal plastic deformation. All structures are printed using the S0.5 resin.

FIG. 17 illustrates cyclic compression test for the impact absorption structure with 19.5% relative density up to compressive strain of 80%. The structure printed from the resin containing 0.5% crosslinker can repeatably deform to 80% strain without experiencing permanent deformation or breaking. The structure exhibits an energy dissipation efficiency of 18.6%.

FIG. 18 illustrates cyclic compression test for the impact absorption structure with 29.0% relative density up to compressive strain of 80%. The structure printed from the resin containing 0.5% crosslinker can repeatably deform to 0.8 strain without experiencing permanent deformation or breaking. The structure exhibits an energy dissipation efficiency of 21.3%.

FIG. 19 illustrates cyclic compression test for the impact absorption structure with 35.3% relative density up to compressive strain of 80%. The structure printed from the resin containing 0.5% crosslinker can repeatably deform to 0.8 strain without permanent deformation or breaking. The structure exhibits an energy dissipation efficiency of 20.3%.

FIG. 20 illustrates cyclic compression of brain tissue mimicking soft gel. Soft silicone gel has a compressive modulus of 29.7 kPa measured at 0.02 strain. Solid line: loading; dashed line: unloading.

FIG. 21 illustrates strain, acceleration, and voltage (force) measured during the impact on the tetrakaidecahedron protection structures. The 3D structures printed from the resin containing 0.5% crosslinker (S0.5) reduces the strain, acceleration, and voltage (force) of the impact. The absorption structures protect the brain-like material by helping to dissipate the impact forces, a unique property enabled by both the softness of the bulk material and the geometry of the 3D printed structures. The impact response varies with the design and the resulting stiffness of the trusses.

### DETAILED DESCRIPTION

The present disclosure provides for resin compositions, polymers made from the resin composition, methods of making the polymer, methods and systems of making structures that include the polymer, and the like.

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer chemistry, synthetic chemistry, and the like, which are within the skill of the art. Such techniques are explained fully in the literature.

The following description and examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar or psig. Standard temperature and pressure are defined as 25° C. and 1 bar.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible. Different stereochemistry is also possible, such as products of cis or trans orientation around a carbon-carbon double bond or syn or anti addition could be both possible even if only one is drawn in an embodiment.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

The term “composition” as used herein refers to a product comprising the specified ingredients in the specified amounts, as well as any product which results, directly or indirectly, from combination of the specified ingredients in the specified amounts.

“Polymers” are understood to include, but are not limited to, homopolymers, copolymers, such as for example, block, graft, random and alternating copolymers, terpolymers, etc. and blends and modifications thereof.

The term “crosslinking” can generally refer to a reaction of a portion of the reactive sites of molecules of a polymer to form cross-linking bonds between molecules of the polymer, where the crosslinks can be a covalent bonds or reversible crosslinks (e.g., hydrogen bonding).

### General Discussion

The present disclosure provides for resin compositions, polymers made from the resin composition, methods of making the polymer, methods of making structures that include the polymer, systems for making the polymer, and the like. The resin composition is relatively inexpensive and can be photocured to produce a polymer than has a dual-crosslinked network that allows for the polymer to the advantageous combination of softness and stretchability that other polymers do not have. The present disclosure provides for the ability to use the resin compositions for high-fidelity additive manufacturing of functional structures and devices made of the polymer that is soft and stretchable.

Additive manufacturing of elastomers enables the fabrication of many technologically important structures and devices. However, it remains a challenge to develop soft and stretchable elastomers for vat photopolymerization (VP) printing, one of the most used additive manufacturing techniques for producing objects with relatively high-resolution and smooth finishes. The present disclosure provides for a modular soft stretchable low-cost elastomer resin for VP printing. The resin includes commodity acrylates and can be photocured to form a dual-crosslinked network containing covalent crosslinks and reversible double hydrogen bonds. Controlling the ratio of covalent and reversible crosslinks enables elastomers with an exceptional combination of softness and stretchability (e.g., Young's modulus of about 20-150 kPa and tensile breaking strain of about 510-1350%) that cannot be achieved by existing VP resins. A system includes a VP printing platform that is used to transform this resin composition into complex three-dimensional (3D) structures. The present disclosure provides for an instrument to show that the 3D structures possess extreme dissipative properties, such that they can protect brain-like soft gels from impact damage in reducing the severity of impact by 75%. Together with the low-cost of raw chemicals and modular nature of the design, these soft stretchable elastomer resins provide a new class of feedstock for high-fidelity additive manufacturing of functional structures.

The present disclosure provides for a resin composition. In an aspect, the resin composition includes an alkyl (e.g., C1 to C5 alkyl group) acrylate monomer, an alkyldiol (e.g., C1 to C5 alkyl group) diacrylate monomer, and a 2-[(alkylamine)carbonyl]oxy] alkyl acrylate monomer (e.g., each alkyl can independently be a C1 to C5 alkyl group). In an embodiment, the resin composition includes a butyl acrylate monomer, a butanediol diacrylate monomer, and a 2-[(ethylamine)carbonyl]oxy]ethyl acrylate monomer. In an aspect, the weight percent (w/w %) of the alkyl (e.g., C1 to C5 alkyl group) acrylate monomer or butyl acrylate monomer in the composition is about 80 to 99 weight percent, about 90 to 99 weight percent, or about 95 to 99 weight %. In an aspect, the weight percent (w/w %) of the alkyldiol (e.g., C1 to C5 alkyl group) diacrylate monomer or butanediol diacrylate monomer in the composition is about 0.01 to 15 weight percent, about 0.01 to 10 weight percent, about 0.01 to 5 weight percent, about 1 to 10 weight percent, about 3 to 10 weight percent, or about 5 to 10 weight percent. In an aspect, the weight percent (w/w %) of the 2-[(alkylamine)carbonyl]oxy] alkyl acrylate monomer (e.g., each alkyl can independently be a C1 to C5 alkyl group) or 2-[(ethylamine)carbonyl]oxy]ethyl acrylate monomer in the composition is about 0.01 to 2 weight percent, about 0.1 to 2 weight percent, about 1 to 2 weight percent, about 0.01 to 1 weight percent, or about 0.01 to 0.1 weight percent.

In an aspect, the photoinitiator can include a UV photoinitiator such as benzophenones (e.g., benzophenone, methyl benzophenone, Michler's ketone, and xanthones), acylphosphine oxide type free radical initiators (e.g., 2,4,6-trimethylbenzoyldiphenyl phosphine oxide (TMPO), 2,4,6-trimethylbenzoylethoxyphenyl phosphine oxide (TEPO), and bisacylphosphine oxides (BAPO's) such as phenylbis(2,4,6-trimethyl benzoyl)phosphine oxide), azo compounds (e.g., AIBN), benzoins, and benzoin alkyl ethers (e.g., benzoin, benzoin methyl ether and benzoin isopropyl ether)). The photoinitiator can have a weight percent (w/w %) in the composition is about 0.01 to 1 weight percent. In an aspect, the photoinitiator is phenyl bis(2,4,6-trimethylbenzoyl)phosphine oxide, where the weight percent of phenyl bis(2,4,6-trimethylbenzoyl)phosphine oxide in the composition is about 0.01 to 1 weight percent.

As described above, the resin composition can be photocured to produce a polymer. The polymer can have the following group:

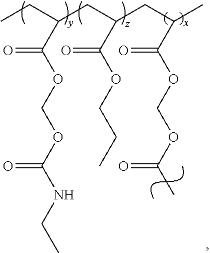

Subscript x can be 1 to 100,000, 1000 to 100,000, 1000 to 10,000, or 10,000 to 100,000. Subscript y can be 1 to 100,000, 1000 to 100,000, 1000 to 10,000, or 10,000 to 100,000. Subscript z can be 1 to 100,000, 1000 to 100,000, 1000 to 10,000, or 10,000 to 100,000.

The polymer is a randomly crosslinked network having at least two types of crosslinks or two types of crosslinks. One of the at least two types of crosslinks (or one of the crosslinks) includes a UV-initiated permanent, covalent bond that crosslinks two polymer chains. One of the at least two types of crosslinks (or one of the crosslinks) is hydrogen bonding that act as a reversible crosslink. The ratio of the covalent bond to the hydrogen bond can be about 1:100 to 1:400, about 1:200 to 1:400, about 1:300 to 1:400, about 1:200 to 1:300, about 1:150 to 1:300, about 1:150 to 1:250, or about 1:200 to 1:380. Including at least these two crosslinks (or two types of crosslinks) enable the polymer to have desirable characteristics such as softness and stretchability.

In an aspect, the polymer is an elastomer. The elastomer can have a Young's modulus of about 10 to 170 kPa, about 20 to 150 kPa, about 50 to 150 kPa, or about 100 to 150 kPa. The elastomer can have a tensile breaking strain of about 450 to 1400%, about 510 to 1350%, about 700 to 1350%, or about 1000 to 1350%. The elastomer can have both the Young's modulus and the tensile breaking strain and in any combination of values described above or herein.

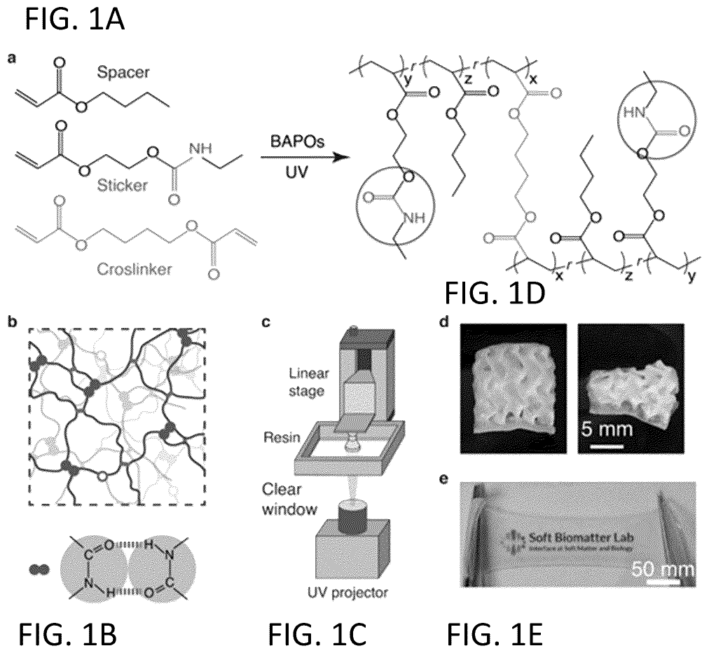

The resin composition can be exposed to UV energy to polymerize the resin composition to form the polymer, where the polymer has the characteristics as described above and herein. In an aspect, the resin composition can be used to make a structure. In an aspect, the structure can be made using the stereolithography printing system described in Example 1 (See FIG. 1C).

For example, the method of making the structure using stereolithography printing can include disposing a first layer of a resin composition, such as those described above or herein, on a surface (e.g., metal, plastic, ceramic, etc.). The term “disposing” can include causing the resin composition to come into contact with the surface, which can include, but is not limited to, causing the surface to contact the resin composition is a container or causing the resin composition to be flowed onto the surface. In a particular aspect, resin composition can include: a butyl acrylate monomer, where the weight percent of the butyl acrylate monomer in the composition is about 90 to 99 weight percent; a butanediol diacrylate monomer, where the weight percent of butanediol diacrylate monomer in the composition is about 0.01 to 10 weight percent; 2-[(ethylamine)carbonyl]oxy]ethyl acrylate monomer, where the weight percent of 2-[(ethylamine)carbonyl]oxy]ethyl acrylate monomer in the composition is about 0.01 to 2 weight percent; and a photoinitiator. Once disposed onto a surface, the first layer of the resin composition is exposed to ultraviolet (UV) energy to polymerize the resin composition to form an elastomer. The exposure to UV energy can be about 3 to 30 seconds. Once the first layer is cured, a second layer of the resin composition can be disposed onto at least the first layer (or onto the first layer). The second layer is then exposed to ultraviolet energy to polymerize the composition to form the elastomer. The structure formed includes the first layer and the second layer. Additional layers can be formed in a similar manner until the desired structure is formed.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

Additive manufacturing (AM) of elastomers enables the fabrication of many technologically important structures and devices, such as soft robots^{1,2}, tissue scaffolds^{3,4}, stretchable electronics⁵, sensors^{6,7}, actuators⁸⁻¹⁰, and dissipative structures¹¹. Among various kinds of methods, vat photopolymerization (VP) printing represents one of the most used additive manufacturing techniques, largely because of its capability in fabricating complex three-dimensional (3D) structures with relatively high resolution and smooth finishes¹². However, the feedstock polymeric resins are limited by the nature of VP printing. In VP printing, a thin layer of liquid photopolymer is selectively solidified by light-activated polymerization. After the layer is cured, the build platform moves vertically, exposing the cured layer to a new layer of liquid resin. This process requires the resin to be of relatively low viscosity, such that the resin can easily flow to replenish the space between the cured part and the light source¹³. Typically, the resin viscosity can be lowered by introducing low-viscosity diluents¹⁴ or solvents¹⁵; however, these additives can leach out or evaporate, impairing the reliability of the printing process and/or deteriorating the mechanical properties of the printed parts. Alternatively, heating the resins reduces their viscosity during printing^{16,17}, yet the reliability of this process is limited by the poor thermal conductivity of photocurable resins. In addition, heating may also promote side reactions, resulting in unpredictable crosslinking kinetics that is critical to successful printing. Through hardware engineering, a recoater is integrated into VP printers to enable printing high-viscosity resins^{18,19}; this improvement significantly broadens the selection of resins for VP printing. Nevertheless, in addition to hardware development, the advancement of VP printing also requires innovation in photocurable resins.

Currently, the majority of VP resins are acrylate-based photocurable polymers, which often form highly crosslinked stiff, brittle networks¹⁹⁻²¹. The commercially available photopolymers for VP printing, including variants such as Continuous Liquid Interface Production (CLIP)²² and Digital Light Processing (DLP)²³, have the lowest Young's modulus of approximately 1 MPa²¹. The Young's modulus of acrylate-based resins can be lowered to ˜500 kPa by optimizing the selection of monomers^{24,25} or to ˜250 kPa by using ionic liquids as fillers²⁶. However, the stiffness of these resins remains to be higher than most soft biological tissues (˜1-˜100 kPa)^{27,28}, limiting their applications where contact with biological objects is required. Instead of using small acrylate-based monomers as precursors, crosslinking precursor polydimethylsiloxane (PDMS) chains by light-triggered thiol-ene click chemistry enables resins with tunable stiffness (Young's modulus E of 6-283 kPa) and stretchability (tensile breaking strain ∈_{f} of 50-400%)²⁰. Introducing a secondary silicone-based network, which can be thermally cured post-printing, results in a dual-network with enhanced mechanical properties (E, 100-670 kPa; ∈_{f}, 180-410%)²⁹. The concept of dual-network has also been extended to creating resins crosslinked by various chemistry; examples include thermally cured isocyanate network³⁰, dynamic covalent bonds^{31,32}, and reversible hydrogen bonds^{33,34}. But in general, these resins are relatively stiff and of low stretchability. Additionally, existing acrylate-based photocurable resins are relatively expensive with cost >$100 kg/L (Table S1). It remains an unmet demand in the development of low-cost, soft, and stretchable elastomeric resins for VP printing.

Here, we report a modular, soft, and stretchable acrylate-based elastomer resin for VP printing. The resin can be photo-crosslinked to form a dual-crosslinked network consisting of covalent crosslinks and reversible double hydrogen bonds. By controlling the ratio of covalent and reversible crosslinks, we create elastomers with unprecedented combinations of softness and stretchability (E, 20-150 kPa; ∈_{f}, 510-1350%). Moreover, the major component of the resin is commodity acrylate, which is >50 times lower in cost compared to existing ones. Using a customized VP printing platform, we transform this resin into complex three-dimensional (3D) structures. Further, we develop an instrument to show that the 3D structures possess extreme dissipative properties, such that they can protect brain-like soft gels from impact damage in reducing the severity of impact by 75%. Together with the low cost of raw chemicals and modular nature of the design, our soft and stretchable elastomer resins provide a new class of feedstock for high-fidelity additive manufacturing of functional structures.

### 2 Results and Discussion

### 2.1 Resin Design and Synthesis

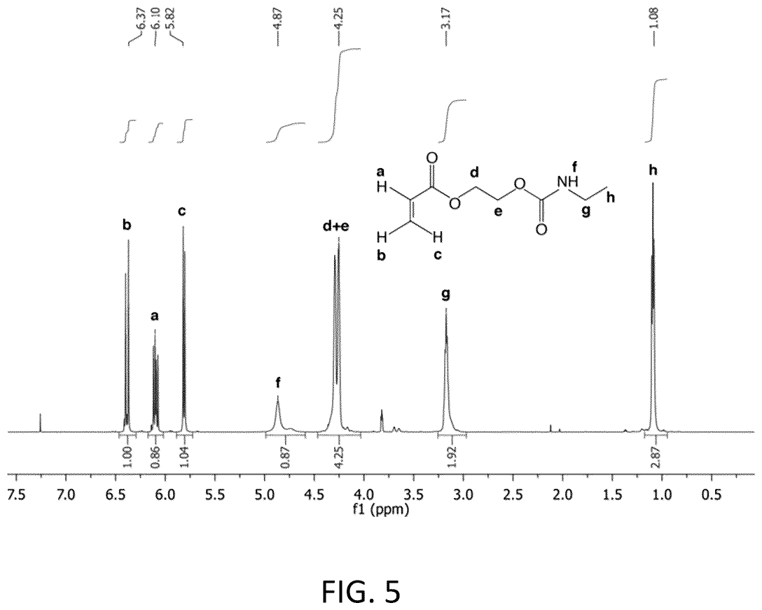

We design the resin using three kinds of monomers, butyl acrylate acting as the “spacer”, butanediol diacrylate as the “crosslinker”, and 2-[(ethylamine)carbonyl]oxy]ethyl acrylate acting as the “sticker” (Table S2). All three monomers are acrylate-based small molecules, which copolymerize to form an optically transparent network under ultraviolet (UV) triggered free radical polymerization in ambient air, as illustrated in FIG. 1A. Both the spacer and crosslinker are commercially available; the sticker is synthesized by the reaction of the isocyanate and alcohol, as detailed in Materials and Methods and confirmed by proton nuclear magnetic resonance spectroscopy (¹H NMR) (FIG. 5). Importantly, the major component of the resin, butyl acrylate, is a commodity with a price of ˜1.3 $/kg when purchased in bulk³⁵. This is over 50 times less expensive than existing commercial elastomeric resins, which are primarily based on specialty acrylate derivatives (Table S3). Even when purchased in small quantities from standard commercial vendors (e.g., MilliporeSigma®), butyl acrylate-based resins are 2-3 times less expensive than common monomers used in other photocurable resins (Table S1). Butyl acrylate is the major component of the resin, which helps minimize the overall cost even when the more expensive sticky monomer, a small portion of the overall resin, is included. Further, the resin without stickers is both 3D printable and possess remarkable mechanical properties. These findings support that our resins are cost-competitive compared with standard commercial ones.

The sticker is essentially the same as the spacer except with one end carrying an amide group. This ensures that the sticker and the spacer have the same reaction rate, such that the sticker and the spacer are randomly distributed along the polymer chains³⁶. Moreover, the stickers can form an amide-amide double-hydrogen bonding^{36,37}, as illustrated by a pair of closed red circles in the lower part of FIG. 1B. The randomly crosslinked network contains two types of crosslinks: (i) UV-initiated permanent, covalent bonds that crosslink two neighboring polymer chains and (ii) hydrogen bonds that act as reversible crosslinks, as shown by the upper part of FIG. 1B. For this dual-crosslinked network, the stiffness can be tuned by adjusting the concentration of the permanent crosslinkers and the energy dissipation efficiency can be tuned by the concentration of stickers. Thus, our design allows for modular control over the network mechanical properties.

### 2.2 Printing Complex 3D Structures

We develop a customized VP platform to print our modular soft elastomers. In our VP printer, a UV projector projects an image and selectively cures the resin to pattern each layer (FIG. 1C). The selective curing process is repeated in a layer-by-layer manner to form 3D structures, as exemplified by a gyroid in FIG. 1D. Unlike typical commercial VP printers that require a relatively large volume of resins, our printing platform requires a small volume of resin (˜1 mL), as long as the resin is sufficient to form one layer during a printing cycle. Importantly, the printing conditions can be customized to meet the crosslinking kinetics of the resin, whether the resin is optically transparent (FIG. 1E) or purposely dyed to be opaque for better visualization (FIG. 1D). This versatility allows for optimized curing time, critical for printing complex structures.

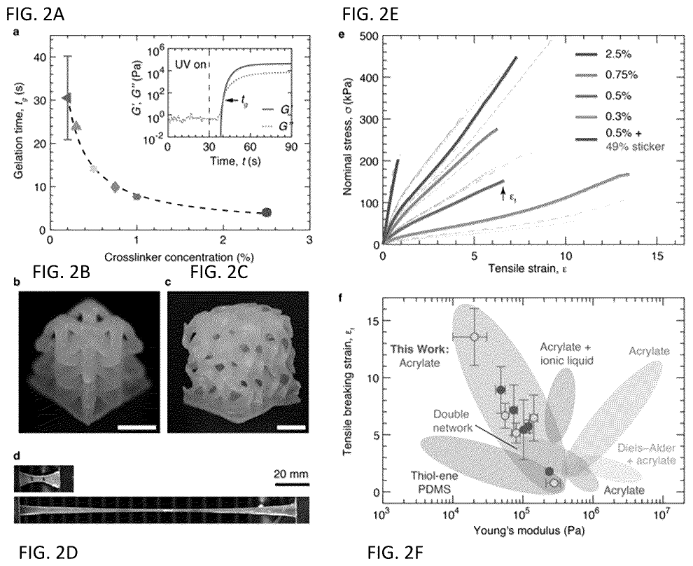

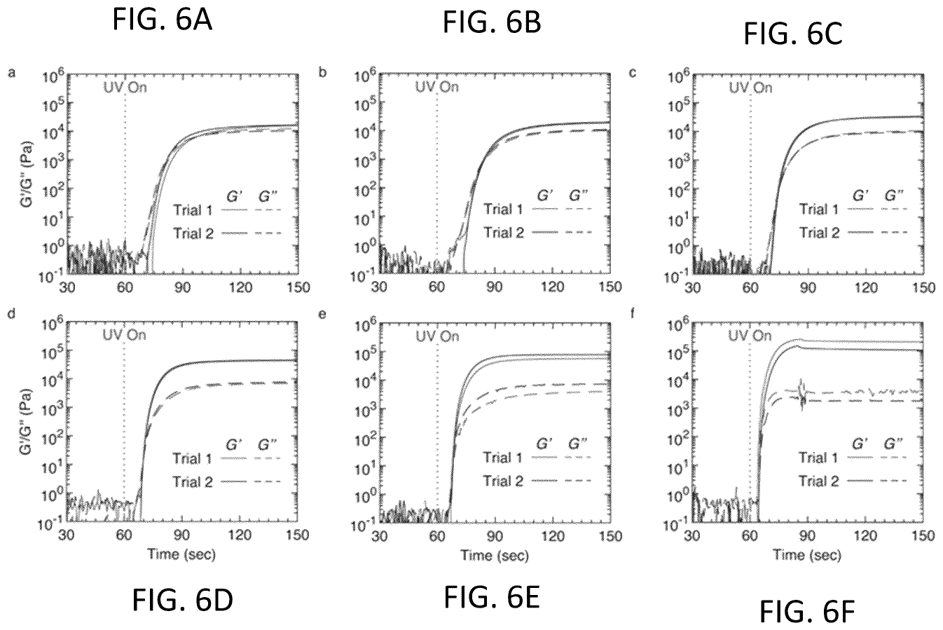

To determine the crosslinking kinetics of our photocurable resins, we monitor their shear moduli during exposure to UV light using a photo-rheometer. We adjust the irradiance of the UV to 17 mW/cm², the lowest value accessible by the rheometer and is close to the 15 mW/cm² irradiance used in VP printing³⁸. We use a plate-plate geometry with a gap of 100 μm, the same as the thickness of each layer during VP printing. The gelation time, t_{g}, is defined as the time beyond which the storage modulus G′ becomes larger than loss modulus G″, as noted by the arrow in the inset of FIG. 2A. At a relatively low crosslinker concentration of 0.2% (S0.2), t_{g}=30.5 sec, which is too long for efficient VP printing. Slightly increasing the crosslinker concentration to 0.3% decreases the t_{g} to 23.9 sec (S0.3). As the crosslinker concentration increases from 0.3% to 2.5%, t_{g} decreases rapidly to 4.0 sec (symbols in FIG. 2A, FIG. 6, and Table S4).

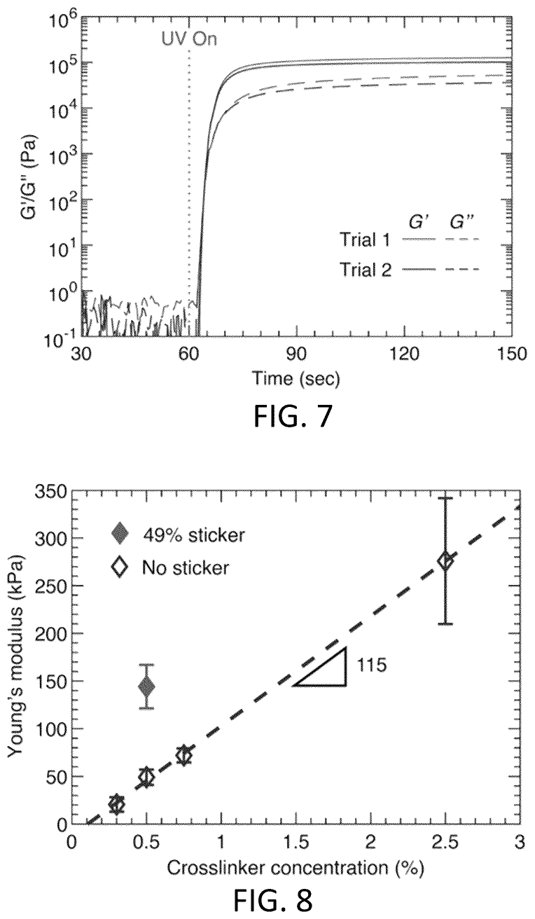

Introducing stickers decreases the gelation time compared to the resin containing only spacer monomers. For instance, for the sample with 0.5% crosslinker, replacing 49% of spacer monomers by sticker monomers reduces the gelation time by more than three times from 14.2 sec to 4.0 sec (FIG. 2A and FIG. 7). This is because the stickers form reversible bonds to crosslink the polymer, effectively reducing the gelation time, as demonstrated in our previous work³⁶. These results indicate as long as crosslinker concentration is no less than 0.3%, the resins have relatively low viscosity and short curing time, allowing them to be suitable for efficient VP printing (Table S4). Indeed, these resins can be successfully printed into a lattice with truss diameter of ˜1 mm (FIG. 2B) and a gyroid with wall thickness of ˜0.3 mm (FIG. 2C). Moreover, the gyroid is highly deformable and can be reversibly squeezed by fingers, as shown in FIG. 1D. These results demonstrate that our soft elastomer resins are suitable for VP printing of complex, complex 3D structures.

### 2.3 Mechanical Properties

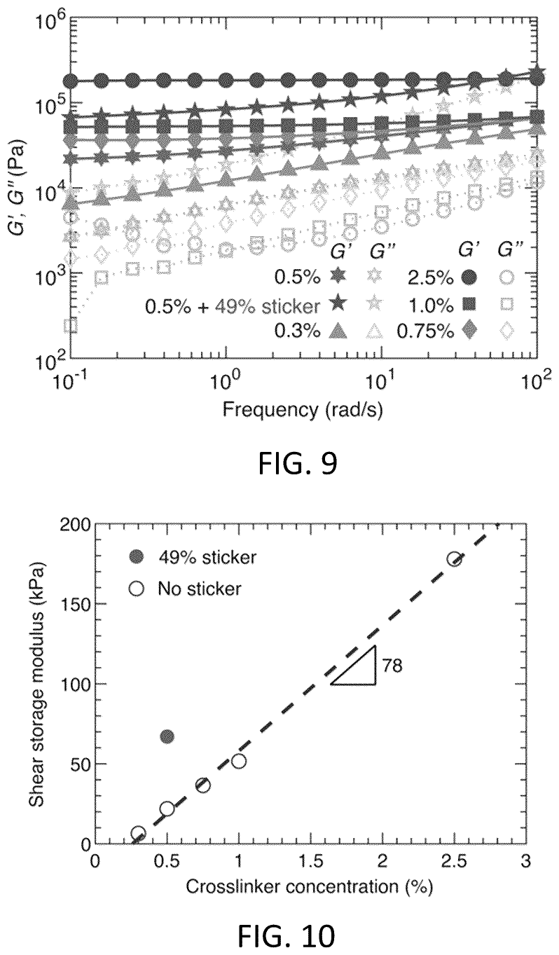

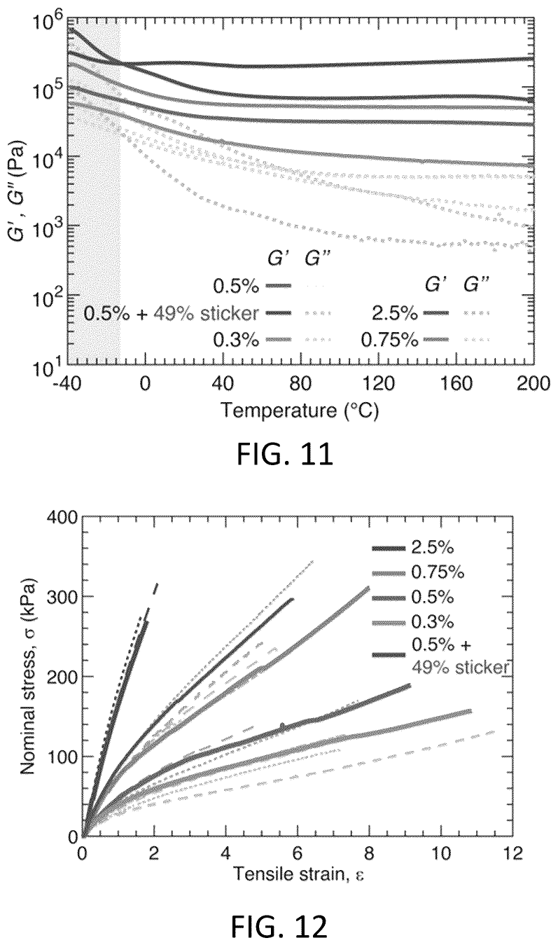

To explore the mechanical properties afforded by our elastomer resins, we conduct uniaxial tensile tests to quantify the extensibility of 3D printed tensile bars. We limit our exploration up to 2.5% crosslinker concentration, above which the resin becomes brittle and is prone to cracking upon photocuring. As the crosslinker concentration decreases from 2.5% to 0.3%, the elastomers become more stretchable with tensile breaking strain ∈_{f} increasing from 76.4% to 1355.6% (FIG. 2E). By contrast, the network Young's modulus decreases linearly the decrease of crosslinker concentration from 278.8 kPa to 20.3 kPa and FIG. 8. This observation is consistent with the network shear modulus, which is nearly a constant over a wide range of oscillatory shear frequency at room temperature (FIG. 9) and increases linearly with the crosslinker concentration (FIG. 10). Importantly, all elastomers are thermostable up to 200° C., the highest temperature accessible by our instrument (FIG. 11). These results confirm the success development of soft, stretchable elastomeric resins.

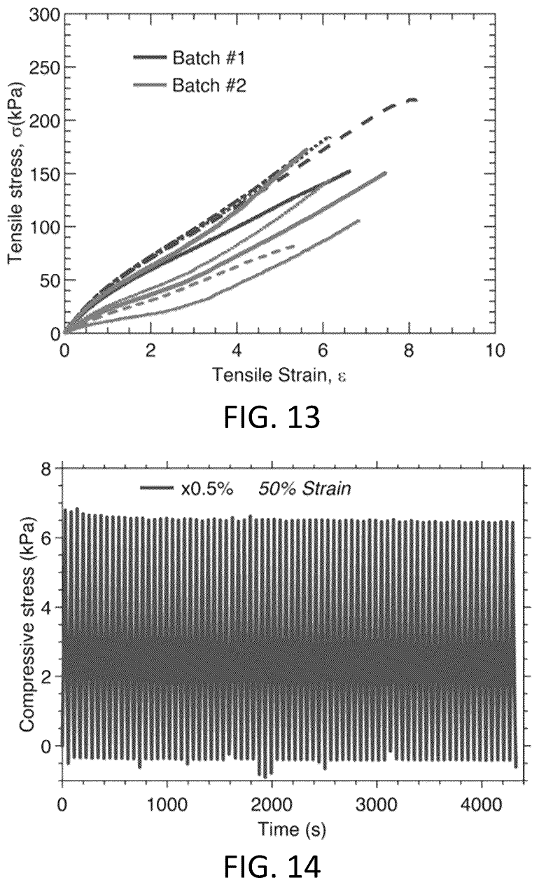

The values of Young's moduli of printed elastomers are comparable to those of molded samples (FIG. 8, Table S5, and Table S8). Notably, the printed samples often exhibit a higher tensile breaking strain than the molded ones (FIG. 12), which are, respectively shown by the filled and empty circles in FIG. 2F. For instance, for the elastomer with 0.3% crosslinker (S0.3), ∈_{f} is 891.8% for the molded sample; by contrast, the printed one exhibits a remarkably high ∈_{f} of 1355.6%, as visualized by the photos in FIG. 2D. This difference is likely because cutting the molded samples into tensile bars introduces defects along the edges of the parts, which could lead to premature fracture of the elastomer. Additionally, we note differences in mechanical properties within samples prepared from the same resin, as shown by the light color lines in FIG. 2E; this is likely because of batch-to-batch variation in resins. For instance, for the resin with 0.5% crosslinker, the difference between two batches is not significant in elongation at break (665.90±109.01% vs 628.87±85.97%), yet becomes significant in modulus (55.81±2.07 kPa vs 25.70±7.78 kPa) (FIG. 2E vs FIG. 13, Table S7). Better understanding the causes of batch-to-batch variations and reducing variability will be the subject of future study. Nevertheless, these results show that the VP printing process does not negatively impact the mechanical properties of the printed parts.

Introducing stickers significantly enhances the mechanical properties of the printed parts. For the resin S0.5 with Young's modulus of 55.8 kPa, replacing 49% of the spacer monomer by the sticker monomer (S0.5-49) increases the modulus by nearly three times to 143.0 kPa (Table S6, FIG. 8). By contrast, the tensile breaking strain remains nearly constant of ˜650% regardless of the presence of stickers. Consequently, the tensile toughness increases by more than twice from 6.7 kJ/m³ to 14.5 kJ/m³. These results indicate that reversible associations enhance network mechanical properties.

Compared to existing acrylate-based resins for VP printing, our elastomers possess an exceptional combination of low stiffness and large extensibility (FIG. 2F). For instance, solely acrylate-based resins have the minimum Young's modulus of ˜400 kPa^{24,25,32} (light blue, magenta, and orange region, FIG. 2F). Filling the acrylate-based resins with ionic liquids reduces the minimum modulus to 270 kPa but does not enhance stretchability (purple region, FIG. 2F)²⁶. Thiol-ene chemistry double-network resins (light green region, FIG. 2F)²⁹ and silicone-based resins (dark green region, FIG. 2f)²⁰ are softer (E, 6-670 kPa) but not very stretchable (∈_{f}<430%)²⁰. Commercially available resins are even more limited with typical ∈_{f}<400% and E>1 MPa (Table S8). By contrast, our acrylate-based resins are both soft and stretchable (E<100 kPa and ∈_{f}>500%; red circles, FIG. 2F). While it is expected that the use of different printers, printing conditions, and testing conditions will result in variations in mechanical properties, our resins possess mechanical properties superior to existing ones (FIG. 2F).

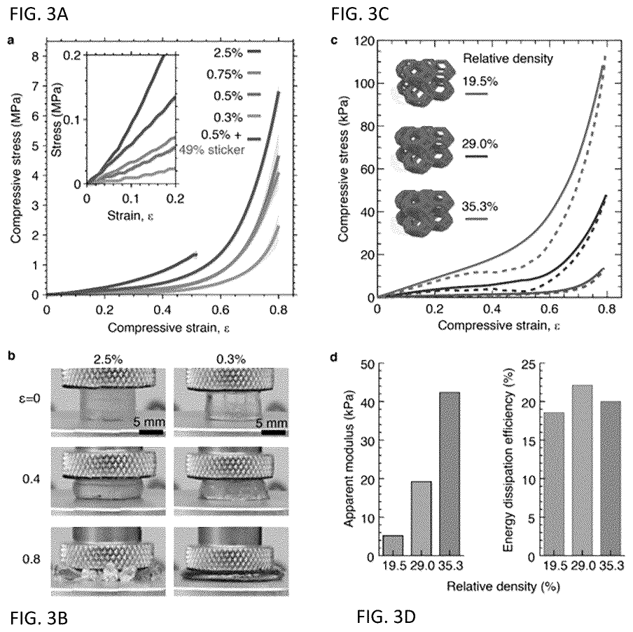

Because the VP printed elastomers exhibit an exceptional combination of softness and stretchability, we explore their capability to withstand large compression, which is often required for applications such as damping structures and soft robots^{39,40}. To do so, we print bulk cylinders with a diameter of 11 mm and height of 6.5 mm. We compress the cylinders at a constant strain rate of 1/30 sec⁻¹ and monitor the compression process using a camera. Remarkably, besides the stiffest sample (S2.5), which fractures at compressive strain ˜50%, all other elastomers can sustain up to 80% compression (FIGS. 3A and B). As the crosslinker concentration increases, the compressive moduli of the 3D printed elastomers increase from 88.1 kPa (S0.3) to 841.7 kPa (S2.5) (FIG. 3A, Table S9). Replacing 49% of the spacer monomer with the sticker monomer in the 0.5% crosslinker material increases the compressive modulus from 209.3 kPa (S0.5) to 602.9 kPa (S0.5+49% sticker). In addition to being soft and deformable, the printed parts show the ability to be repeatably compressed without suffering a significant decrease in mechanical properties. For instance, when the printed gyroid (FIG. 2C) is compressed to 50% strain for 100 cycles (FIG. 14), the maximum stress only decreases by ˜5% (from 6.79 to 6.43 kPa). These results demonstrate our elastomer resins exhibit extreme mechanical properties in response to both tensile and compressive loadings.

2.4 Printing Dissipative Structures for Protecting Soft Brain-Like Gels from Impact Damage

To highlight the potential applications of VP printing of soft stretchable elastomers, we explore the possibility in creating 3D structures with extreme dissipative structures for protecting brain-like gel from impact damage, which is critical for preventing traumatic brain injury (TBI)⁴¹. Depending on the location of the tissue and loading conditions, brain tissue varies in stiffness but generally has a compressive modulus between 1 and 50 kPa^{42,43}. To protect against brain injuries, a material should not only efficiently dissipate energy but also reduce acceleration during an impact. This typically requires a protective structure to be relatively soft and highly deformable (i.e. 60-80% compression strain) without dramatic stiffening⁴⁴. Polymer foams are commonly used to achieve this behavior45,46 but lack control over the 3D structure. Yet recent advancements have started to show that designing 3D structures with unique geometries promises optimum compression behavior for impacts^{47,48}.

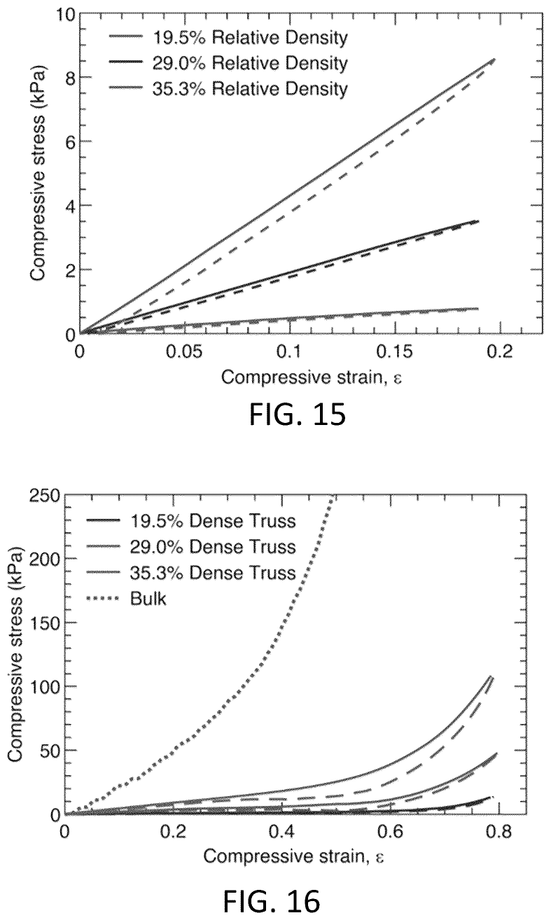

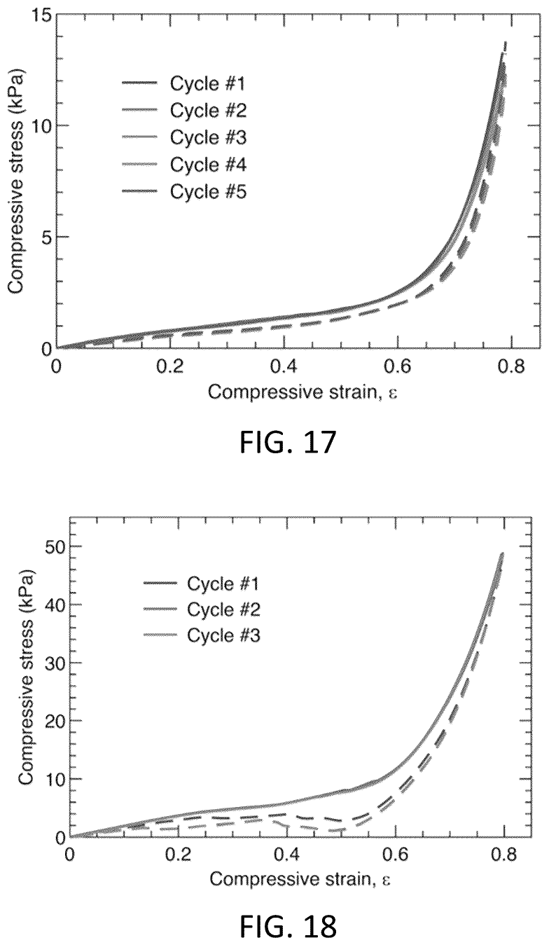

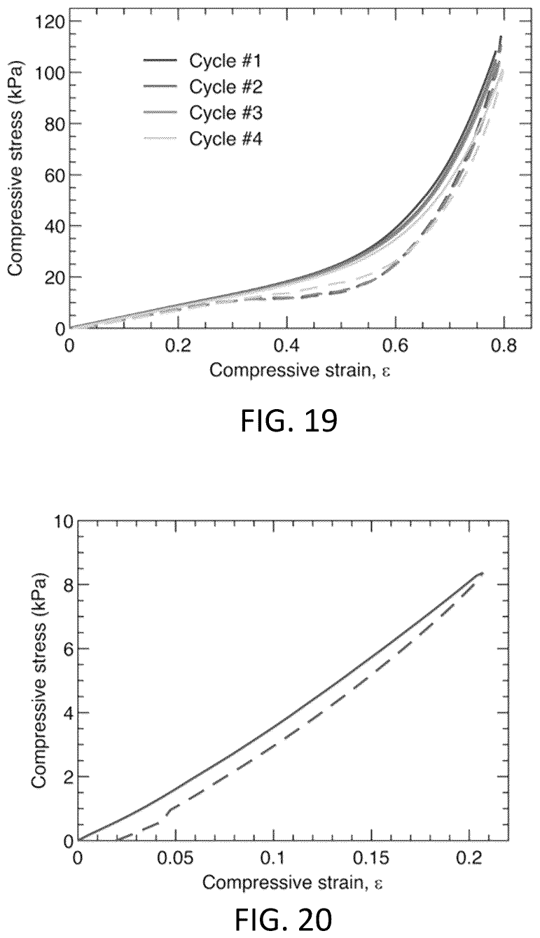

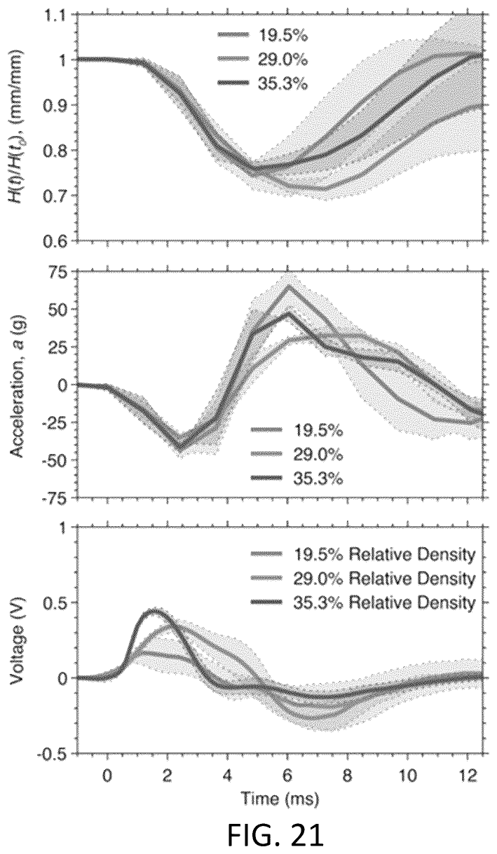

Instead of designing new 3D structures, we choose the classic tetrakaidecahedron lattices, or Kelvin foam, as protection structures; this allows for highlighting the dissipative properties enabled by the soft elastomeric resins⁴⁹⁻⁵². We use our customized VP printer to transform the S0.5 resin into a 3D structure consisting of 2×2×2-unit cells with nominal dimensions of 2×2×2cm. We change only the diameter of the truss members to achieve different relative densities of 19.5, 29.0, and 35.3%, which correspond to apparent compressive moduli of 5.2 kPa, 19.2 kPa, and 42.4 kPa, respectively (FIGS. 3C and d, FIG. 15). These stiffnesses are dramatically lower than the bulk 0.5% crosslinker material (S0.5) with a compressive modulus of 209.3 kPa (FIG. 16). Regardless of their relative density, all tetrakaidecahedron structures can be repeatedly compressed to 80% strain without fracturing (FIG. 3C, FIGS. 17-19). The energy dissipation efficiency, defined as the ratio of the area enclosed by the loading-unloading hysteresis loop to the area under the loading curve, is 18.6, 21.3, and 20.0% for the 19.5, 29.0, and 35.3% relative density structures, respectively (FIG. 3C). Moreover, the compressive stress of the 3D structures is dramatically lower than that of the bulk counterpart. For instance, at 40% strain, the 3D structure with 29.0% relative density exhibits a stress of 6.0 kPa, nearly 25 times lower than 146.9 kPa for the bulk material (FIG. 15). For the 3D printed structures, there exists a wide window of compressive strain up to ˜60%, within which the compressive stress is nearly plateaued. By contrast, for the bulk material, the stress starts to increase dramatically at a relatively low strain of ˜30%. These results highlight the ability of 3D printed soft, elastomeric architectures to be deformed by a large extent to efficiently dissipate energy without being stiffened.

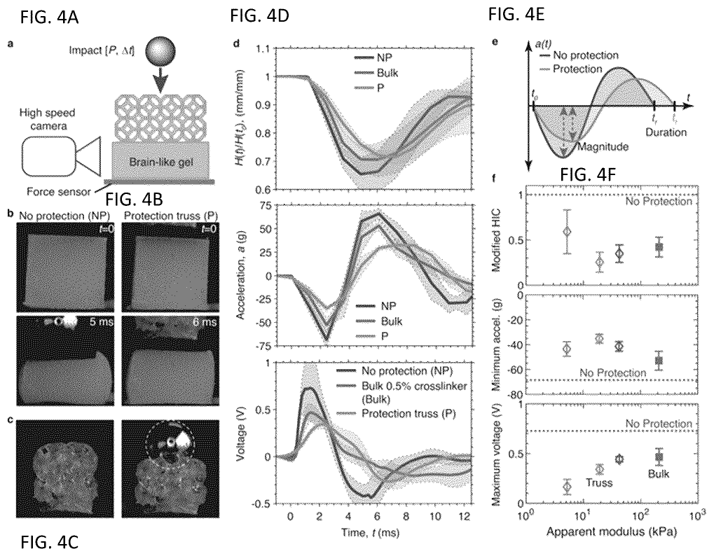

To mimic the brain tissue, we use a silicone gel with a compressive modulus of 29.7 kPa (FIG. 20); this gel is close to the intermediate stiffness of the brain tissue while possessing enough strength to repeatedly absorb impacts without permanent deformation. We develop an instrument to quantify in real time the ability of 3D-printed structures to protect the brain-like soft gel. In a typical measurement, we load a 3D-printed structure on top of the soft gel, which is placed on a piezoelectric force sensor, and drop a stainless-steel ball with 12.7 mm in diameter (8.35 g) from 580 mm height. Simultaneously, a high-speed camera is used to monitor the whole impact process, as illustrated in FIG. 4A. The high-speed camera takes images at 826 frames per second (fps), which is sufficient for monitoring the deformation of the brain-like soft gel in real time. In parallel, the piezoelectric sensor proportionally converts the applied force to output voltage, which is recorded at a relatively high rate of 10,000/sec. A custom MATLAB program initiates and synchronizes the dropping of the ball and beginning data collection from the high-speed camera and piezoelectric sensor.

During impact, both the protecting 3D structure and the soft brain-like gel rapidly deform, as shown by the high-speed images in FIGS. 4A B and C. After impact, both the 3D structure and the gel rebound and return to their initial position. Based on the image series, we extract the height of the soft brain-like gel and calculate the average strain and acceleration associated with the gel deformation, as shown in FIG. 4A D and listed in Table S10.

Simultaneously, we record the voltage from the piezoelectric sensor which is proportional to the impact force. The extremely short response time (˜1 ms) of the piezoelectric sensor allows for quantifying the dynamic change of force during the impact test. We repeat each measurement at least five times to ensure sufficiently powered statistics. With the protection of a 3D printed structure, the maximum extent of deformation is not only reduced but also delayed (FIG. 4A D, i). In delaying the impact, the protection structure reduces acceleration (FIG. 4A D, ii). Likewise, the voltage magnitude and thus the impact force is reduced across the whole impact tests (FIG. 4A D, iii). Over multiple experimental impact trials, no significant change in the impact absorption behavior or physical damage of the scaffolds was observed. This observation indicates that the printed structures can withstand repeated straining without notable impairment in mechanical performance (FIG. 14). These results highlight the ability of 3D printed soft and stretchable elastomers to protect the soft brain-like gel from repeated impacts.

Both the magnitude and the duration of the acceleration are critical to determining the severity of a TBI⁴¹. For instance, the brain can sustain high accelerations without injury but only for a very short period. Conversely, relatively low accelerations over long periods can cause severe damage. Thus, the head impact criteria (HIC)⁴¹ is often used to measure the likelihood of head injury arising from an impact. To quantify the difference in impact response among various protection structures, we introduce the modified head impact criteria (mHIC), a dimensionless parameter that incorporates both the magnitude and duration of the acceleration⁴¹:

$$mHIC = {( {t}_{2} - {t}_{1} ) [ \frac{1}{{t}_{2} - {t}_{1}} {\int }_{{t}_{1}}^{{t}_{2}} \vert a ( t ) \vert dt ]}^{2.5} \qquad Equation 1$$

where t₁=0 sec, t₂ is the time when the ball leaves the 3D structure (˜10 ms), and a(t) is the measured acceleration over time, as illustrated in FIG. 4A E. The mHIC is normalized to the impact on the brain-like gel without any protection and the result, presented as a percentage, represents the relative reduction in severity of the impact the different protection structures provide. The bulk 0.5% crosslinker elastomer alone reduces the mHIC from 100% to (42.1±10.9) %, the magnitude of peak deceleration decreases from 68.5±8.5 g to 52.9±7.6 g, and the maximum voltage decreases from 0.73±0.35 V to 0.46±0.09 V (FIG. 4A F and Table S10). Note that we use voltage to characterize the relative change of the force during impact tests because piezoelectric sensors cannot reliably measure static force (Materials and Methods). These results show that the inherent softness of the bulk elastomer helps reduce the severity of the impact.

Transforming the bulk soft elastomer to the even softer architected 3D structures further enhances the ability to protect the soft brain-like gel from impact. For instance, the magnitude of peak deceleration is reduced from 52.9±7.6 g (bulk S0.5) to 41.4±3.9 g for the structure with 35.3% relative density (FIG. 4A F, ii). The mHIC is reduced to (35±10) %. Further decreasing the relative density to 29.0% also decreases the magnitude of peak deceleration to 35.2±3.6 g and decreases the mHIC to (25±11) %. For the 3D structure with the lowest relative density of 19.5% and the lowest apparent modulus of 5.2 kPa, the magnitude of peak deceleration increases to 43.5±5.9 g and the mHIC increases to (59±24) % (FIG. 4A F, i). The increase in peak deceleration is likely because the softest structure deforms too easily and does not dissipate sufficient energy during the impact, resulting in more energy being transferred to the brain-like gel than the stiffer structures. This observation highlights the importance of matching the apparent stiffness of a protective structure to the expected impact; this could be achieved by tuning the stiffness of the bulk resin and the geometry of the printed structure. Taken together, our results suggest that, in addition to materials stiffness, relative density is an important parameter in the design of the protection structures.

### 3. Conclusion and Outlook

In summary, we have developed a modular, soft, and stretchable elastomer resin for VP printing. The resin consists of three acrylate-based monomers that can be photo-crosslinked to form a dual-crosslinked network, including covalent crosslinks and reversible amide-amide hydrogen bonds. This design enables modular control over network mechanical properties. For instance, the Young's modulus of the resin is linearly proportional to the concentration of crosslinkers. Introducing stickers increases the network stiffness without impairing network stretchability. By controlling the ratio of covalent and reversible crosslinks, we create elastomers with an exceptional combination of softness and stretchability (E, 20-150 kPa; ∈_{f}, 500-1360%) that cannot be achieved by existing VP resins including those commercially available and reported in literature. Importantly, the major component of our resin is based on a commodity acrylate, >50 times lower in cost compared to existing commercial ones.

Using a customized VP printing platform, we demonstrate that our resins can be transformed to complex, architecturally complex 3D structures. Because of extreme softness and stretchability of our resins, the printed 3D structures exhibit remarkable dissipative properties. The structures deform easily at relatively low stress (5-40 kPa) but without significant stiffening until a large extent of compression (60% compressive strain). We demonstrate that the soft, elastic, and dissipative structures can protect brain-like gels from impact damage in reducing the severity of impact up to 75%, highlighting the potential applications in preventing traumatic brain injury.

We note that the potential of our modular resin has yet to be fully explored. For instance, reversible bonds not only slow down polymer dynamics to enhance dissipative properties⁵³, but also increase the glass transition temperature of polymers³⁶. This may allow the material to behave like stiff plastics at room temperature, providing modular resins of the same crosslinking chemistry but dramatically different mechanical properties for multi-material VP printing^{10,54}. The only sticker concentration explored in this work is 49% with 0.5% covalent crosslinker. Systematic investigations into the roles of hydrogen bonds on the mechanical properties of the resins and the dissipative properties of the printed 3D structures are beyond the scope of this work and will be the subject of future explorations. Additionally, incorporating ionic liquids may allow the resins to be electrically conductive, resulting in soft, stretchable, and conductive elastomers^{26,55,56}. Although VP printed structures made of our soft and stretchable resins can sustain repeated large compression (FIG. 14)⁵⁷. Note that the volatility of butyl acrylate may affect the printing reliability. To mitigate this, in our experiments, we synthesize fresh batches of resin before printing. Butyl acrylate often has an unpleasant odor; thus, our manufacturing process is performed inside a fume hood. Together with the low cost of raw chemicals and extreme mechanical properties, our modular elastomer resins provide a new class of soft and stretchable materials for high-fidelity additive manufacturing of functional structures and devices.

### References

(1) Skylar-Scott, M. A.; Mueller, J.; Visser, C. W.; Lewis, J. A. Voxelated Soft Matter via Multimaterial Multinozzle 3D Printing. Nature 2019, 575 (7782), 330-335. https://doi.org/10.1038/s41586-019-1736-8.
(2) Kim, Y.; Yuk, H.; Zhao, R.; Chester, S. A.; Zhao, X. Printing Ferromagnetic Domains for Untethered Fast-Transforming Soft Materials. Nature 2018, 558 (7709), 1-6. https://doi.org/10.1038/s41586-018-0185-0.
(3) Hung, K.; Tseng, C.; Hsu, S. Synthesis and 3D Printing of Biodegradable Polyurethane Elastomer by a Water-based Process for Cartilage Tissue Engineering Applications. Adv Healthc Mater 2014, 3 (10), 1578-1587.
(4) Camarero-Espinosa, S.; Calore, A.; Wilbers, A.; Harings, J.; Moroni, L. Additive Manufacturing of an Elastic Poly (Ester) Urethane for Cartilage Tissue Engineering. Acta Biomater 2020, 102, 192-204.
(5) Zhou, L.; Fu, J.; Gao, Q.; Zhao, P.; He, Y. All-Printed Flexible and Stretchable Electronics with Pressing or Freezing Activatable Liquid-Metal-Silicone Inks. Adv Funct Mater 2020, 30 (3), 1906683. https://doi.org/https://doi.org/10.1002/adfm.201906683.
(6) Muth, J. T.; Vogt, D. M.; Truby, R. L.; Mengüç, Y.; Kolesky, D. B.; Wood, R. J.; Lewis, J. A. Embedded 3D Printing of Strain Sensors within Highly Stretchable Elastomers. Advanced Materials 2014, 26 (36), 6307-6312. https://doi.org/10.1002/adma.201400334.
(7) Emon, M. O. F.; Alkadi, F.; Philip, D. G.; Kim, D.-H.; Lee, K.-C.; Choi, J.-W. Multi-Material 3D Printing of a Soft Pressure Sensor. Addit Manuf 2019, 28, 629-638. https://doi.org/https://doi.org/10.1016/j.addma.2019.06.001.
(8) Schaffner, M.; Faber, J. A.; Pianegonda, L.; Rühs, P. A.; Coulter, F.; Studart, A. R. 3D Printing of Robotic Soft Actuators with Programmable Bioinspired Architectures. Nat Commun 2018, 9 (1), 878. https://doi.org/10.1038/s41467-018-03216-w.
(9) Kotikian, A.; Truby, R. L.; Boley, J. W.; White, T. J.; Lewis, J. A. 3D Printing of Liquid Crystal Elastomeric Actuators with Spatially Programed Nematic Order. Advanced Materials 2018, 30 (10), 1-6. https://doi.org/10.1002/adma.201706164.
(10) Ge, Q.; Chen, Z.; Cheng, J.; Zhang, B.; Zhang, Y. F.; Li, H.; He, X.; Yuan, C.; Liu, J.; Magdassi, S.; Qu, S. 3D Printing of Highly Stretchable Hydrogel with Diverse UV Curable Polymers. Sci Adv 2021, 7 (2), 1-11. https://doi.org/10.1126/sciadv.aba4261.
(11) Luo, C.; Chung, C.; Traugutt, N. A.; Yakacki, C. M.; Long, K. N.; Yu, K. 3D Printing of Liquid Crystal Elastomer Foams for Enhanced Energy Dissipation Under Mechanical Insult. ACS Appl Mater Interfaces 2021, 13 (11), 12698-12708. https://doi.org/10.1021/acsami.0c17538.
(12) Zhou, L.; Fu, J.; He, Y. A Review of 3D Printing Technologies for Soft Polymer Materials. 2020, 2000187, 1-38. https://doi.org/10.1002/adfm.202000187.
(13) Wang, K.; Pan, W.; Liu, Z.; Wallin, T. J.; van Dover, G.; Li, S.; Giannelis, E. P.; Menguc, Y.; Shepherd, R. F. 3D Printing of Viscoelastic Suspensions via Digital Light Synthesis for Tough Nanoparticle-Elastomer Composites. Advanced Materials 2020, 32 (25), 1-8. https://doi.org/10.1002/adma.202001646.
(14) Hevus, I.; Kannaboina, P.; Qian, Y.; Wu, J.; Johnson, M.; Gibbon, L. R.; Scala, J. J. La; Ulven, C.; Sibi, M. P.; Webster, D. C. Furanic (Meth) Acrylate Monomers as Sustainable Reactive Diluents for Stereolithography. ACS Appl Polym Mater 2023, 5 (11), 9659-9670.
(15) White, B. T.; Meenakshisundaram, V.; Feller, K. D.; Williams, C. B.; Long, T. E. Vat Photopolymerization of Unsaturated Polyesters Utilizing a Polymerizable Ionic Liquid as a Non-Volatile Reactive Diluent. Polymer (Guildf) 2021, 223, 123727.
(16) Steyrer, B.; Busetti, B.; Harakály, G.; Liska, R.; Stampfl, J. Hot Lithography vs. Room Temperature DLP 3D-Printing of a Dimethacrylate. Addit Manuf 2018, 21, 209-214.
(17) Hamachi, L. S.; Rau, D. A.; Arrington, C. B.; Sheppard, D. T.; Fortman, D. J.; Long, T. E.; Williams, C. B.; Dichtel, W. R. Dissociative Carbamate Exchange Anneals 3D Printed Acrylates. ACS Appl Mater Interfaces 2021, 13 (32), 38680-38687.
(18) Weng, Z.; Huang, X.; Peng, S.; Zheng, L.; Wu, L. 3D Printing of Ultra-High Viscosity Resin by a Linear Scan-Based Vat Photopolymerization System. Nat Commun 2023, 14 (1), 4303.
(19) Rau, D. A.; Forgiarini, M.; Williams, C. B. Hybridizing Direct Ink Write and Mask-Projection Vat Photopolymerization to Enable Additive Manufacturing of High Viscosity Photopolymer Resins. Addit Manuf 2021, 42, 101996. https://doi.org/10.1016/j.addma.2021.101996.
(20) Wallin, T. J.; Pikul, J. H.; Bodkhe, S.; Peele, B. N.; Mac Murray, B. C.; Therriault, D.; McEnerney, B. W.; Dillon, R. P.; Giannelis, E. P.; Shepherd, R. F. Click Chemistry Stereolithography for Soft Robots That Self-Heal. J Mater Chem B 2017, 5 (31), 6249-6255. https://doi.org/10.1039/c7tb01605k.
(21) Herzberger, J.; Sirrine, J. M.; Williams, C. B.; Long, T. E. Polymer Design for 3D Printing Elastomers: Recent Advances in Structure, Properties, and Printing. Prog Polym Sci 2019, 97, 101144.
(22) Tumbleston, J. R.; Shirvanyants, D.; Ermoshkin, N.; Janusziewicz, R.; Johnson, A. R.; Kelly, D.; Chen, K.; Pinschmidt, R.; Rolland, J. P.; Ermoshkin, A. Continuous Liquid Interface Production of 3D Objects. Science (1979) 2015, 347 (6228), 1349-1352.
(23) Zhao, Z.; Tian, X.; Song, X. Engineering Materials with Light: Recent Progress in Digital Light Processing Based 3D Printing. J Mater Chem C Mater 2020, 8 (40), 13896-13917.
(24) Patel, D. K.; Sakhaei, A. H.; Layani, M.; Zhang, B.; Ge, Q.; Magdassi, S. Highly Stretchable and UV Curable Elastomers for Digital Light Processing Based 3D Printing. Advanced Materials 2017, 29 (15), 1-7. https://doi.org/10.1002/adma.201606000.
(25) Bhattacharjee, N.; Parra-Cabrera, C.; Kim, Y. T.; Kuo, A. P.; Folch, A. Desktop-stereolithography 3D-printing of a Poly (Dimethylsiloxane)-based Material with Sylgard-184 Properties. Advanced materials 2018, 30 (22), 1800001.
(26) He, X.; Cheng, J.; Li, Z.; Ye, H.; Wei, X.; Li, H.; Wang, R.; Zhang, Y. F.; Yang, H. Y.; Guo, C.; Ge, Q. Multimaterial Three-Dimensional Printing of Ultraviolet-Curable Ionic Conductive Elastomers with Diverse Polymers for Multifunctional Flexible Electronics. ACS Appl Mater Interfaces 2022. https://doi.org/10.1021/acsami.2c18954.
(27) Levental, I.; Georges, P. C.; Janmey, P. A. Soft Biological Materials and Their Impact on Cell Function. Soft Matter 2007, 3 (3), 1-9. https://doi.org/10.1039/b610522j.
(28) Cai, L.-H.; Kodger, T. E.; Guerra, R. E.; Pegoraro, A. F.; Rubinstein, M.; Weitz, D. A. Soft Poly(Dimethylsiloxane) Elastomers from Architecture-Driven Entanglement Free Design. Advanced Materials 2015, 27 (35), 5132-5140. https://doi.org/10.1002/adma.201502771.
(29) Wallin, T. J.; Simonsen, L. E.; Pan, W.; Wang, K.; Giannelis, E.; Shepherd, R. F.; Mengüç, Y. 3D Printable Tough Silicone Double Networks. Nat Commun 2020, 11 (1), 1-10. https://doi.org/10.1038/s41467-020-17816-y.
(30) Ren, C.; Deng, Y.; Bao, J. Highly Stretchable Dual-cure Photosensitive Resin for Digital Light Processing Printing. J Appl Polym Sci 2022, 139 (27), e52455.
(31) Cheng, K.; Chortos, A.; Lewis, J. A.; Clarke, D. R. Photoswitchable Covalent Adaptive Networks Based on Thiol-Ene Elastomers. ACS Appl Mater Interfaces 2022, 14 (3), 4552-4561.
(32) Durand-Silva, A.; Cortés-Guzmán, K. P.; Johnson, R. M.; Perera, S. D.; Diwakara, S. D.; Smaldone, R. A. Balancing Self-Healing and Shape Stability in Dynamic Covalent Photoresins for Stereolithography 3D Printing. ACS Macro Lett 2021, 10 (4), 486-491.
(33) Cosola, A.; Sangermano, M.; Terenziani, D.; Conti, R.; Messori, M.; Grützmacher, H.; Pirri, C. F.; Chiappone, A. DLP 3D-Printing of Shape Memory Polymers Stabilized by Thermoreversible Hydrogen Bonding Interactions. Appl Mater Today 2021, 23, 101060.
(34) Gao, H.; Sun, Y.; Wang, M.; Wang, Z.; Han, G.; Jin, L.; Lin, P.; Xia, Y.; Zhang, K. Mechanically Robust and Reprocessable Acrylate Vitrimers with Hydrogen-Bond-Integrated Networks for Photo-3D Printing. ACS Appl Mater Interfaces 2020, 13 (1), 1581-1591.
(35) BusinessAnalytiq. Butyl Acrylate price index. Price Indexes. https://businessanalytiq.com/procurementanalytics/index/butyl-acrylate-price-index/.
(36) Nian, S.; Patil, S.; Zhang, S.; Kim, M.; Chen, Q.; Zhernenkov, M.; Ge, T.; Cheng, S.; Cai, L.-H. Dynamics of Associative Polymers with High Density of Reversible Bonds. Phys Rev Lett 2023, 130 (22), 228101.
(37) Wu, J.; Cai, L. H.; Weitz, D. A. Tough Self-Healing Elastomers by Molecular Enforced Integration of Covalent and Reversible Networks. Advanced Materials 2017, 29 (38), 1702616. https://doi.org/10.1002/adma.201702616.
(38) Rau, D. A.; Reynolds, J. P.; Bryant, J. S.; Bortner, M. J.; Williams, C. B. A Rheological Approach for Measuring Cure Depth of Filled and Unfilled Photopolymers at Additive Manufacturing Relevant Length Scales. Addit Manuf 2022, 60, 103207. https://doi.org/10.1016/j.addma.2022.103207.
(39) Kotikian, A.; McMahan, C.; Davidson, E. C.; Muhammad, J. M.; Weeks, R. D.; Daraio, C.; Lewis, J. A. Untethered Soft Robotic Matter with Passive Control of Shape Morphing and Propulsion. Sci Robot 2019, 4 (33), eaax7044.
(40) Montgomery, S. M.; Hilborn, H.; Hamel, C. M.; Kuang, X.; Long, K. N.; Qi, H. J. The 3D Printing and Modeling of Functionally Graded Kelvin Foams for Controlling Crushing Performance. Extreme Mech Lett 2021, 46, 101323.
(41) Fernandes, F. A. O.; Sousa, R. J. A. de. Head Injury Predictors in Sports Trauma-a State-of-the-Art Review. Proc Inst Mech Eng H 2015, 229 (8), 592-608.
(42) Chatelin, S.; Constantinesco, A.; Willinger, R. Fifty Years of Brain Tissue Mechanical Testing: From in Vitro to in Vivo Investigations. Biorheology 2010, 47 (5-6), 255-276.
(43) Tamura, A.; HAYASHI, S.; Watanabe, I.; NAGAYAMA, K.; Matsumoto, T. Mechanical Characterization of Brain Tissue in High-Rate Compression. Journal of biomechanical science and engineering 2007, 2 (3), 115-126.
(44) Lu, G.; Yu, T. X. Energy Absorption of Structures and Materials; Elsevier, 2003.
(45) Tomin, M.; Kmetty, A. Polymer Foams as Advanced Energy Absorbing Materials for Sports Applications-A Review. J Appl Polym Sci 2022, 139 (9), 51714.
(46) Li, S.; Li, Q. M.; Tse, K. M.; Pang, T. Functionally Graded Foam Materials for Head Impact Protection. Thin-Walled Structures 2024, 203, 112193.
(47) Siegkas, P.; Sharp, D. J.; Ghajari, M. The Traumatic Brain Injury Mitigation Effects of a New Viscoelastic Add-on Liner. Sci Rep 2019, 9 (1), 3471.
(48) Wiśniewska, K.; Jędrzejewska, A.; Ratajczak, M.; Klekiel, T. Analysis of the Mechanical Properties of Impact Absorbing Structures Used in Military Helmets. In Biocybernetics and Biomedical Engineering-Current Trends and Challenges: Proceedings of the 22nd Polish Conference on Biocybernetics and Biomedical Engineering, Warsaw, Poland, May 19-21, 2021; Springer, 2022; pp 17-28.
(49) Ge, C.; Priyadarshini, L.; Cormier, D.; Pan, L.; Tuber, J. A Preliminary Study of Cushion Properties of a 3D Printed Thermoplastic Polyurethane Kelvin Foam. Packaging Technology and Science 2018, 31 (5), 361-368.
(50) Gong, L.; Kyriakides, S.; Triantafyllidis, N. On the Stability of Kelvin Cell Foams under Compressive Loads. J Mech Phys Solids 2005, 53 (4), 771-794.
(51) Okumura, D.; Okada, A.; Ohno, N. Buckling Behavior of Kelvin Open-Cell Foams under [0 0 1], [0 1 1] and [1 1 1] Compressive Loads. Int J Solids Struct 2008, 45 (13), 3807-3820.
(52) Jiang, Y.; Wang, Q. Highly-Stretchable 3D-Architected Mechanical Metamaterials. Sci Rep 2016, 6 (1), 34147.
(53) Kim, M.; Nian, S.; Rau, D. A.; Huang, B.; Zhu, J.; Freychet, G.; Zhernenkov, M.; Cai, L. H. 3D Printable Modular Soft Elastomers from Physically Cross-Linked Homogeneous Associative Polymers. ACS Polymers Au 2024. https://doi.org/10.1021/acspolymersau.3c00021.
(54) Yue, L.; Macrae Montgomery, S.; Sun, X.; Yu, L.; Song, Y.; Nomura, T.; Tanaka, M.; Jerry Qi, H. Single-Vat Single-Cure Grayscale Digital Light Processing 3D Printing of Materials with Large Property Difference and High Stretchability. Nat Commun 2023, 14 (1), 1-12. https://doi.org/10.1038/s41467-023-36909-y.
(55) Narupai, B.; Wong, J.; Sanchez-Rexach, E.; Smith-Jones, J.; Le, V. C. T.; Sadaba, N.; Sardon, H.; Nelson, A. 3D Printing of lonic Liquid Polymer Networks for Stretchable Conductive Sensors. Adv Mater Technol 2023, 8 (23), 1-9. https://doi.org/10.1002/admt.202300226.
(56) He, X.; Cheng, J.; Li, Z.; Ye, H.; Sun, Z.; Liu, Q.; Li, H.; Wang, R.; Ge, Q. Stretchable Ultraviolet Curable lonic Conductive Elastomers for Digital Light Processing Based 3D Printing. Adv Mater Technol 2023, 8 (13), 1-8. https://doi.org/10.1002/admt.202202088.
(57) Kim, J.; Zhang, G.; Shi, M.; Suo, Z. Fracture, Fatigue, and Friction of Polymers in Which Entanglements Greatly Outnumber Cross-Links. Science (1979) 2021, 374 (6564), 212-216.
(58) Bauer, P.; Denk, P.; Fuss, J. M.; Lorber, K.; Ortner, E.; Buettner, A. Correlations between Odour Activity and the Structural Modifications of Acrylates. Anal Bioanal Chem 2019, 411, 5545-5554.

### Supplemental Information for Example 1

### Materials and Methods

Materials. Ethyl isocyanate (98%), 2-hydroxyethyl acrylate (96%), hydroquinone (≥99%), dibutyltin dilaurate (DBTDL, 95%), butanediol diacrylate (BDDA, 95%), and phenylbis (2,4,6-trimethylbenzoyl) phosphine oxide (BAPOs, 97%) were purchased from Sigma Aldrich. Butyl acrylate (BA, >99%) and avobenzone (>98%) were purchased from TCI. All chemicals are used as received unless notified otherwise.

Synthesis of sticky monomer 2-[[ethyl(amine)carbonyl]oxy]ethyl acrylate (EAEA). The sticky monomer is synthesized using alcoholysis reaction. First, a round flask is settled with a condenser for reflux. The flask is charged with ethyl isocyanate (25 g, 0.35 mol), DBTDL (125 mg, 0.05% mass fraction of isocyanate), and hydroquinone (77 mg, 0.2% mole fraction of isocyanate) under nitrogen. The flask is sealed and stirred for 15 min in an ice bath. The ice bath is replaced by an oil bath and then 2-hydroxyethyl acrylate (40.642 g, 0.35 mol) is added dropwise with vigorous stirring under nitrogen at 40° C. After finishing the addition of 2-hydroxyethyl acrylate, the reaction mixture is stirred at 60° C. for 4 hours. The success of the synthesis is confirmed by ¹H NMR (600 MHz, CDCl₃) δ=1.00 (t, 3H), 3.17 (m, 2H), 4.25 (m, 4H), 4.87 (s, 1H), 5.82 (d, 1H), 6.10 (dd, 1H), 6.38 (d, 1H) (FIG. 5).

Preparation of photocurable resin. The soft photocurable resin is prepared by mixing BA, BDDA, and BAPOs at the ratios described in Table S1. Avobenzone was added into the mixture at 0.1 wt. % of total resin as a UV absorber to improve the printing quality by reducing the scattering of light. Afterward, the mixture was bubbled with nitrogen for 30 min to remove oxygen under vigorous stirring. The resin containing sticky monomers is prepared by mixing BA, EAEA, BDDA, and BAPOs at the ratios listed in Table S1. Again, avobenzone was added at 0.1wt. % of total resin and the mixture bubbled with nitrogen for 30 min to remove oxygen under vigorous stirring.

Vat photopolymerization 3D printing. Vat photopolymerization (VP) 3D printing was completed on a custom built system consisting of a Wintech PRO6500 UV Projector (385 nm), a Zaber X-LSQ150A linear stage, and a Sovol resin vat with a clear fluorinated ethylene propylene (FEP) window. Printing was completed using 100 μm layer thickness and a UV irradiance set to 17 mW/cm². Layer UV Exposure times for each resin were determined through experimention with a 5 sec expsoure time per layer being used for the 2.5% crosslinker sample, 9 sec for the 0.75% crosslinker, 12 sec for the 0.5% crosslinker, and 15 sec for the 0.3% crosslinker. Variation in the gelation time measured with photorheology and the exposure times used in printing is primarily due to the slight difference in the UV sources between the printer and the photorheoemter. The photorheometer is equipped with a broad range UV source with an installed filter that reduces the wavelength range to between 320 and 395 nm. Conversely, the UV projector has a 385 nm LED UV source. After printing, parts were washed with isopropanol alcohol and further cured in a Formlabs Form Cure system at 60° C. for one hour.

Dynamic mechanical tests. Tensile and compression testswere completed on a Mark-10 ESM303 motorized test stand. A 10 N load cell was used for tensile testing and a 50 N load cell was used for compression testing. The test stand was set to the lowest speed possible, 13 mm/minute, corresponding to an average strain rate of 0.052 s⁻¹ for the 3D-printed samples and 0.022 s⁻¹ for the cast samples

Photorheology, frequency sweeps, and temperature sweeps were completed on astress controlled rheometer (Anton Paar MCR302) to measure the curing behavior of the resins and mechanical properties of the cured materials. For photorheology, an 8 mm diameter parallel plate geometry, a 100 μm gap, 17 mW/cm² UV irradiance, 0.5% strain, 1 Hz frequency, and the photocuring accessory were used. UV exposure began 60 s into the experiment to allow the resin time to equilibrate and a total of 300 s of UV exposure was used. For the frequency sweeps, an 8 mm diameter parallel plate geometry, a 100 μm gap, 0.5% strain, 20° C. constant temperature, and a frequency range from 0.1 to 100 Hz were used. For the temperature sweep, an 8 mm diameter parallel plate geometry, a 100 μm gap, 0.5% strain, and 1 Hz frequency were used. The temperature was ramped from −40 to 200° C. at a rate of 3° C./min.

Impact Studies. Impact studies were completed using the experimental setup illustrated in FIG. 4a. A Fastec IL5-S high speed camera was used to record images at 826 fps. A long working distance objective was focused on the brain tissue mimicking soft gel. The light-colored silicones contrasted with the much darker surroundings. An image processing program was developed in Matlab to extract the height of the soft gel over time by thresholding the brightness of each pixel in the image. Pixels with a grayscale brightness of over 40 out of 255 were used to identify the dimensions of the soft gel. The height of the soft gel was averaged over the center 50% of the image to account for any local variation or noise.

A 10×17 mm poly (vinylidene fluoride) (PVDF) piezoelectric sensor from MEAS was used to measure the force of the impacts. The voltage output from the sensor was read directly using a National Instruments USB-6003 data aqcuisition device recoridng at 10 KHz. A 1 MΩ resistor was used to protect the device from over voltage damage. Typically, a piezoelectric sensor begins to discharge its voltage rapidly after being strained and is not capable of providing steady state measurements. However, the short time scales of the impacts (less than 15 ms) makes the piezoelectric sensor suitable for measuring the force of these impacts. Therefore, we decided to use voltage to characterize the relative change of the force during impact tests. The piezoelectric sensor was fixed to a stiff table. The soft gel and protection stuctures were then attached using silicone grease. This grease provides the necessary adhesion while allowing the soft gel to freely deform under impact.

To synchronize various data sources, we used a data acquisition device (DAQ) to continously monitor the state of the electromagnet. When the DAQ sensed that the electromagnet was turned off, meaning that the steel ball began dropping, the DAQ sent a signal to the camera to begin recording and at the same time began recording of the voltage signal. Simulatenosuly, the high-speed camera is used to capture the deformation of the soft gels.

The silicone based brain-mimicking soft gels was created by adding Smooth-On Slacker at 20 wt % to Smooth-On Ecoflex 00-20 and mixing vigorously. The material was then cured at 80° C. for 24 hours.

When calculating the modified Head Impact Criteria (mHIC) (eq. 1, main text), the magnitude and duration of the acceleration between the time the falling ball first contacts the sample and the time when the sample rebounds to its initial position was considered. Analysis of the impact images shows that when the sample returns to its initial height the ball stops contacting the sample and is ejected. At the same time, the acceleration is equal to zero. This occurs between approximately 10 and 12 ms in experiments.

TABLE S1
Price of commonly used monomers in photocurable resins
List of commonly used monomers for photocurable resins provided by Mendes-
Felipe et al. (2019)¹. All prices are from MilliporeSigma as of
October 2024. Monomers are at least 99% purity and typically contain
monomethyl ether hydroquinone as an inhibitor.

| Name | Chemical specie | $/Liter |
|---|---|---|
| Butyl Acrylate (BA) | Monoacrylate | $65.60 |
| 2-Ethylhexyl acrylate (EHA) | Monoacrylate | $52.50 |
| 2-hydroxyethyl methacrylate (2-HEMA) | Monomethacrylate | $54.40 |
| Methyl methacrylate (MMA) | Monomethacrylate | $70 |
| Hydroxypropyl methacrylate (HPMA) | Monomethacrylate | $206 |
| Poly(ethylene glycol) diacrylate (PEGDA) | Diacrylate | $587.00 |
| 1,4-butanediol diacrylate (BDDA) | Diacrylate | $306.00 |
| Diethylene glycol diacrylate (DEGDA) | Diacrylate | $935.00 |
| Urethane acrylate methacrylate | Dimethacrylate | $5770 |
| (UDMA) | | |
| Pentaerythritol triacrylate (PETA) | Triacrylates | $1010.00 |
| Pentaerythritol tetraacrylate | Tetracrylates | $627.00 |
| Diethylene glycol divinyl ether (DEGDE) | Vinyl ethers | $3740.00 |
| 1,4-Cyclohexanedimethanoldivinyl ether (CHDMDE) | Vinyl ethers | $956.00 |
| Triethylene glycol divinyl ether(TEGDE) | Vinyl ethers | $271.00 |
| Styrene | — | $57.00 |
| N-vinyl pyrrolidone (NVP) | — | $213.20 |
| 3,4-Epoxycyclohexylmethyl-3′,4′-epoxycyclohexane | Epoxides | $976.00 |
| carboxylate | | |
| Diclycidylether derivative ofbisphenol A (ADE) | Epoxides | $175.60 |

TABLE S2
Formulations of soft, stretchable elastomeric resins for VP printing. The resin includes a spacer
(BA), sticker (EAEA), and crosslinker (BDDA) monomers, which can form a network under ultraviolet
triggered free radical polymerization with the help from a photoinitiator (BAPO).

| Sample | BA | BDDA | EAEA | BAPOs | Avobenzone | | | | Crosslinker |
|---|---|---|---|---|---|---|---|---|---|
| Name | (mmol) | (mmol) | (mmol) | (mmol) | (wt. %) | x | y | z | (%) |
| S0.3 | 19.5 | 0.029 | — | 0.039 | 0.1 | 0.375 | 0 | 249.25 | 0.3 |
| S0.5 | 19.5 | 0.049 | — | 0.039 | 0.1 | 0.625 | 0 | 248.75 | 0.5 |
| S0.75 | 19.5 | 0.074 | — | 0.039 | 0.1 | 0.937 | 0 | 248.12 | 0.75 |
| S1.0 | 19.5 | 0.098 | — | 0.039 | 0.1 | 1.250 | 0 | 247.50 | 1 |
| S2.5 | 19.5 | 0.25 | — | 0.040 | 0.1 | 3.125 | 0 | 243.75 | 2.5 |
| S0.5 + 49% | 9.8 | 0.049 | 9.7 | 0.039 | 0.1 | 0.625 | 123.75 | 125 | 0.5 |
| sticker | | | | | | | | | |

TABLE S3
Cost of commercially available elastomeric resins for VP printing.
Commercial resins are significantly more expensive than the commodity
acrylate, butyl acrylate, which is the majority component of the resins.

| | | Young's | | | |
|---|---|---|---|---|---|
| | | modulus | Tensile | | |
| | | or Shore A | Breaking | | |
| Manufacturer | Name | hardness | Strain | Cost | Source |
| Formlabs | Elastic 50A | N/A | 160% | 199$ per liter | ² |
| | | 50A | | | |
| Formlabs | Silicone 40A | N/A | 230% | 349$ per Liter | ³ |
| | | 40A | | | |
| Carbon | EPU 40 | 8 MPa | 300% | ~250$ per L, | ⁴ |
| | | 68A | | estimated. Requires | |
| | | | | printer subscription | |
| | | | | to purchase | |
| Carbon | SIL30 | N/A | 350% | ~250$ per L, | ⁵ |
| | | 35A | | estimated, Requires | |
| | | | | printer subscription | |
| | | | | to purchase | |
| Spot-A | Elastic | N/A | 65% | 64$ per L | ⁶ |
| Materials | | 65A | | | |
| 3D Systems | Rubber-65A | 23 MPa | 126% | 249$ per Kg | ⁷ |
| | | 65A | | | |
| Liqcreate | Flexible-X | N/A | 160% | 140$ per Kg | ⁸ |
| | | 55A | | | |
| 3Dresyns | Bioflex A10 | <1 MPa | >300% | 385$ per Kg | ⁹ |
| | MF | 10A | | | |
| resione | F39T | 2 MPA | 255% | 75$ per Kg | ¹⁰ |
| | | 60A | | | |
| Adaptive3D | Soft | N/A | 255% | 175$ per Kg | ¹¹ |
| | ToughRubber | 28.6 A | | | |
| Adaptive3D | Elastic | N/A | 400% | 175$ per Kg | ¹² |
| | ToughRubber | 70A | | | |
| | 70 | | | | |
| Henkel | IND402 | 42 MPa | 230% | 300$ per Kg | ¹³ |
| | | 76A | | | |

TABLE S4
UV curing properties.
Gelation time decreases and cured storage modulus increases
with increasing crosslinker and sticker concentrations.

| | Gelation time | Storage modulus after | Loss tan δ of |
|---|---|---|---|
| Formulation | (s) | being cured (kPa) | the cured resin |
| S2.5 | 4.06 ± 0.69 | 184.21 ± 0 | 0.02 ± 0.00 |
| S1.0 | 7.68 ± 0.10 | 65.5 ± 10.8 | 0.09 ± 0.01 |
| S0.75 | 9.90 ± 0.14 | 44.8 ± 1.3 | 0.17 ± 0.01 |
| S0.5 | 14.17 ± 0.51 | 35.5 ± 1.6 | 0.30 ± 0.01 |
| S0.3 | 23.88 ± 0.04 | 21.9 ± 0.9 | 0.52 ± 0.01 |
| S0.2 | 30.52 ± 9.66 | 18.4 ± 0.4 | 0.67 ± 0.10 |
| S0.5 + 49% | 4.04 ± 0.05 | 122.0 ± 21.2 | 0.42 ± 0.05 |
| Sticker | | | |

TABLE S5
Tensile properties of molded elastomers.
Elastomers possess an exceptional combination of softness and stretchability.

| | | | | Tensile |
|---|---|---|---|---|
| | Stress at break | Strain at break | Young's modulus | toughness |
| Formulation | (kPa) | (%) | (kPa) | (kJ/m³) |
| S2.5 | 285.2 ± 26.8 | 177.6 ± 25.2 | 237.7 ± 11.9 | 2.8 ± 0.6 |
| S0.75 | 228.8 ± 82.1 | 542.9 ± 261.6 | 102.3 ± 22.8 | 8.0 ± 5.8 |
| S0.5 | 164.8 ± 26.4 | 714.3 ± 220.2 | 73.9 ± 9.7 | 7.2 ± 3.2 |
| S0.3 | 129.9 ± 17.8 | 891.8 ± 203.7 | 48.4 ± 7.7 | 9.3 ± 1.6 |
| S0.5 + 49% sticker | 279.1 ± 53.1 | 572.8 ± 56.8 | 120.2 ± 13.6 | 9.4 ± 2.5 |

TABLE S6
Tensile properties 3D printed elastomers.
Resins with crosslinker concentration lower than 0.75% introduces a new range of
softness with strain at break for photocurable and 3D printable materials.

| | | | | Tensile |
|---|---|---|---|---|
| | Stress at break | Strain at break | Young's modulus | toughness |
| Formulation | (kPa) | (%) | (kPa) | (kJ/m³) |
| S2.5 | 199.2 ± 18.8 | 76.4 ± 18.4 | 278.8 ± 64.6 | 0.8 ± 0.3 |
| S0.75 | 244.4 ± 26.1 | 514.1 ± 87.8 | 80.0 ± 11.1 | 6.9 ± 1.9 |
| S0.5 | 182.5 ± 28.1 | 665.9 ± 109.0 | 55.8 ± 2.1 | 6.7 ± 2.2 |
| S0.3 | 116.4 ± 39.5 | 1355.6 ± 249.4 | 20.3 ± 10.3 | 7.2 ± 2.8 |
| S0.5 + 49% sticker | 397.0 ± 80.0 | 646.2 ± 201.0 | 143.0 ± 18.3 | 14.5 ± 6.3 |

TABLE S7
Batch-to-batch comparison of 0.5% crosslinker samples.

| | | | P-value |
|---|---|---|---|
| | Batch #1 | Batch #2 | Comparison |
| Strain | 665.90 ± 109.01 | 628.87 ± 85.97 | 0.5852 |
| Stress | 182.49 ± 28.05 | 131.54 ± 36.69 | 0.0564 |
| Modulus | 55.81 ± 2.07 | 25.70 ± 7.78 | 0.0001 |
| Number of Samples: | 4 | 5 | |

TABLE S8
List of data points in FIG. 2F.
Mechanical properties of existing VP printable materials.

| | | | Tensile | |
|---|---|---|---|---|
| | Color/ | Young's | Breaking | |
| Chemistry | Symbol | Modulus (Pa) | Strain | Reference |
| Thiol-ene | Dark | 83,000 | 1.10 | Wallin et al. |
| | Green | 56,000 | 1.11 | (2017)¹⁴ |
| | | 19,000 | 1.85 | |
| | | 6,000 | 4.27 | |
| | | 223,000 | 0.48 | |
| | | 287,000 | 0.54 | |
| | | 85,000 | 0.76 | |
| | | 32,000 | 1.51 | |
| | | 9,000 | 3.48 | |
| Thiol-ene and | Light | 670,000 | 1.8 | Wallin et al. |
| silicone | Green | 560,000 | 2.4 | (2022)¹⁵ |
| condensation | | 220,000 | 2.8 | |
| dual network | | 100,000 | 4.11 | |
| Methacrylate | Pink | 937,000 | 0.70 | Bhattacharjee |
| | | 750,000 | 0.95 | et al. |
| | | 680,000 | 1.10 | (2018)¹⁶ |
| | | 600,000 | 1.25 | |
| | | 550,000 | 1.50 | |
| | | 520,000 | 1.60 | |
| Acrylate | Light | 7,660,000 | 10.45 | Patel et al. |
| | Blue | 7,110,000 | 10.34 | (2017)¹⁷ |
| | | 4,640,000 | 9.95 | |
| | | 2,810,000 | 8.53 | |
| | | 1,400,000 | 4.98 | |
| | | 1,040,000 | 3.49 | |
| | | 700,000 | 2.52 | |
| | | 420,000 | 1.90 | |
| Diels-Alder and | Orange | 740,000 | 2.46 | Durand-Silva |
| acrylate | | 1,190,000 | 1.91 | et al. |
| | | 3,580,000 | 1.28 | (2021)¹⁸ |
| Acrylate and | Dark | 273,420 | 5.04 | He et al. |
| ionic liquid | Blue | 284,850 | 5.84 | (2022)¹⁹ |
| | | 302,960 | 7.23 | |
| | | 328,760 | 8.32 | |
| | | 384,780 | 9.70 | |

TABLE S9
Compression properties of our 3D printed resins.
Resins with crosslinker concentration lower than
2.5% can sustain up to 80% compression.

| | Compressive Modulus | Toughness at 80% |
|---|---|---|
| Formulation | (kPa) | (kJ/m³) |
| S2.5 | 841.7 ± 41.7 | 0.4 ± 0.0 |
| S0.75 | 257.5 ± 19.3 | 1.5 ± 0.1 |
| S0.5 | 209.3 ± 11.9 | 1.5 ± 0.3 |
| S0.3 | 88.1 ± 0.0 | 0.3 ± 0.0 |
| S0.5 + 49% sticker | 602.9 ± 3.9 | 3.5 ± 0.5 |

TABLE S10
Characteristics of 3D printed structures under impact.
The soft architected 3D structures decrease the severity of the impact by
reducing maximum deformation, peak deceleration, and maximum voltage.

| | Maximum | Minimum | Maximum | | |
|---|---|---|---|---|---|
| | acceleration | acceleration | deformation | Maximum | Modified head |
| Condition | (g's) | (g's) | (mm/mm) | voltage (V) | impact criteria |
| No protection | 65.7 ± 6.2 | −68.5 ± 8.5 | 0.35 ± 0.06 | 0.73 ± 0.35 | 1 ± 0.24 |
| Bulk 0.5% | 52.9 ± 5.7 | −52.9 ± 7.6 | 0.29 ± 0.06 | 0.46 ± 0.09 | 0.42 ± 0.11 |
| crosslinker | | | | | |
| material | | | | | |
| 19.5% relative | 64.9 ± 12.7 | −43.5 ± 5.9 | 0.26 ± 0.03 | 0.16 ± 0.08 | 0.59 ± 0.24 |
| density | | | | | |
| 29.0% relative | 32.5 ± 6.0 | −35.2 ± 3.6 | 0.29 ± 0.03 | 0.34 ± 0.05 | 0.25 ± 0.11 |
| density | | | | | |
| 35.3% relative | 46.8 ± 5.1 | −41.4 ± 3.9 | 0.24 ± 0.01 | 0.44 ± 0.03 | 0.35 ± 0.10 |
| density | | | | | |

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A composition comprising:
a butyl acrylate monomer, wherein the weight percent of the butyl acrylate monomer in the composition is about 90 to 99 weight percent;
a butanediol diacrylate monomer, wherein the weight percent of butanediol diacrylate monomer in the composition is about 0.01 to 10 weight percent; and
2-[(ethylamine)carbonyl]oxy]ethyl acrylate monomer, wherein the weight percent of 2-[(ethylamine)carbonyl]oxy]ethyl acrylate monomer in the composition is about 0.01 to 2 weight percent.

2. The composition of claim 1, further comprising a photoinitiator.

3. The composition of claim 2, wherein the photoinitiator is selected from phenyl bis(2,4,6-trimethylbenzoyl)phosphine oxide, wherein the weight percent of phenyl bis(2,4,6-trimethylbenzoyl)phosphine oxide in the composition is about 0.01 to 1 weight percent.

4. A composition comprising a polymer having the following group: 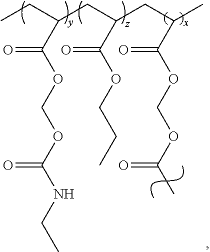
wherein x is 1 to 100,000, wherein y is 1 to 100,000, wherein z is 1 to 100,000.

5. The composition of claim 4, wherein the polymer is a randomly crosslinked network having at least two types of crosslinks, wherein the at least two types of crosslinks include a UV-initiated permanent, covalent bond that crosslinks two polymer chains and hydrogen bonding that act as a reversible crosslink.

6. The composition of claim 5, wherein a ratio of the covalent bond to the hydrogen bond can be about 1:200 to 1:400.

7. The composition of claim 4, wherein the polymer is an elastomer, wherein the elastomer has a Young's modulus of about 20 to 150 kPa.

8. The composition of claim 4, wherein the polymer is an elastomer, wherein the elastomer has a tensile breaking strain of about 510 to 1350%.

9. The composition of claim 4, wherein the polymer is an elastomer, wherein the elastomer has a Young's modulus of about 20 to 150 kPa and a tensile breaking strain of about 510 to 1350%.

10. A method of making a structure using stereolithography printing, comprising:
disposing a first layer of a composition, wherein the composition comprises:
a butyl acrylate monomer, wherein the weight percent of the butyl acrylate monomer in the composition is about 90 to 99 weight percent;
a butanediol diacrylate monomer, wherein the weight percent of butanediol diacrylate monomer in the composition is about 0.01 to 10 weight percent;
2-[(ethylamine)carbonyl]oxy]ethyl acrylate monomer, wherein the weight percent of 2-[(ethylamine)carbonyl]oxy]ethyl acrylate monomer in the composition is about 0.01 to 2 weight percent; and
a photoinitiator;
exposing the first layer to ultraviolet energy to polymerize the composition to form an elastomer;
disposing a second layer of the composition onto at least the first layer; and
exposing the second layer to ultraviolet energy to polymerize the composition to form the elastomer, wherein the structure comprises the first layer and the second layer.

11. The method of claim 10, wherein the elastomer having the following group: 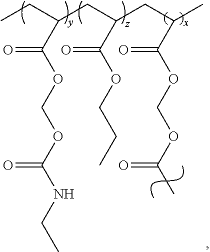
wherein x is 1 to 100,000, wherein y is 1 to 100,000, wherein z is 1 to 100,000.

12. The method of claim 11, wherein the elastomer has a Young's modulus of about 20 to 150 kPa.

13. The method of claim 11, wherein the elastomer has a tensile breaking strain of about 510 to 1350%.

14. The method of claim 11, wherein the elastomer has a Young's modulus of about 20 to 150 kPa, and a tensile breaking strain of about 510 to 1350%.

15. The method of claim 11, wherein the elastomer is a randomly crosslinked network having at least two types of crosslinks, wherein the at least two types of crosslinks include a UV-initiated permanent, covalent bond that crosslinks two polymer chains and hydrogen bonding that act as a reversible crosslink.

16. The method of claim 15, wherein a ratio of the covalent bond to the hydrogen bond can be about 1:200 to 1:380.
